(19) United States
(12) Patent Application Publication
(10) Pub. No.: US 2025/0227794 A1
(43) Pub. Date: Jul. 10, 2025

(54) METHODS AND APPARATUS FOR MOBILITY PROCEDURES FOR HIGHLY DIRECTIONAL SYSTEMS

(71) Applicants: InterDigital Patent Holdings, Inc., Wilmington, DE (US); New York University, New York, NY (US)

(72) Inventors: Sanjay Goyal, Deer Park, NY (US); Umer Salim, Vallauris (FR); Mustafa Furkan Ozkoc, Elmhurst, NY (US); Ravikumar Pragada, Warrington, PA (US); Pascal Adjakple, Great Neck, NY (US); Athanasios Koutsaftis, Brooklyn, NY (US); Pei Liu, Falls Church, VA (US); Shivendra Panwar, Freehold, NJ (US)

(21) Appl. No.: 18/851,344

(22) PCT Filed: Mar. 28, 2023
(86) PCT No.: PCT/US2023/016611

§ 371 Date: Sep. 26, 2024

Related U.S. Application Data
(60) Provisional application No. 63/324,916, filed on Mar. 29, 2022.

(51) Int. Cl. H04W 76/19; H04L 5/00; H04W 8/22; H04W 24/10

(52) U.S. Cl. CPC H04W 76/19; H04L 5/0051; H04W 8/22; H04W 24/10

(57) ABSTRACT

A method, implemented in a wireless transmit/receive unit, WTRU, comprising: sending, to a network, information indicating a capability for determining WTRU orientations associated with receive beams: receiving information indicating a plurality of sets of parameters associated with a beam failure detection and recovery, BFDR, procedure, the plurality of sets of parameters being associated with a plurality of receive beams, respectively, and each of the plurality of sets of parameters comprises criteria and one or more WTRU orientations associated with a receive beam of the plurality of receive beams: determining, a BFDR configuration corresponding to a second of the plurality of receive beams based upon a first of the plurality of receive beams and based upon a second WTRU orientation associated with the second receive beam based on one or more measurements; and performing a BFDR procedure for the second receive beam based on the criteria and the second WTRU orientation.

### CROSS-REFERENCE TO RELATED APPLICATIONS

The present application claims the benefit of U.S. Provisional Patent Application No. 63/324,916 filed Mar. 29, 2022, which is incorporated herein by reference.

### FIELD OF THE INVENTION

This disclosure pertains to methods and apparatus for mobility procedures for highly directional system.

### BACKGROUND

It is known that various aspects that limit the field of view of wireless transmit/receive units (WTRUs) may be due to: (i) HW/FW capability such as multi-panel availability, number of transceiver chains, and computational capability; (ii) WTRU QOS in terms of power consumption, feasibility of making measurements in view of available HW and active flows/services and (iii) network ability and resource provisioning to timely provide measurement gaps for the WTRUs. The limitation of WTRU field of view may result in services outages. Effective methods need to be developed to cope with such problems.

### SUMMARY

In an embodiment, a method, implemented in a Wireless Transmit/Receive Unit, may comprise a step of sending, to a network, information indicating a capability for determining WTRU orientations associated with receive beams. The method may further comprise a step of receiving information indicating a plurality of sets of parameters associated with beam failure detection and recovery procedure, wherein the plurality of sets of parameters are associated with a plurality of receive beams, respectively, and wherein each set of parameters of the plurality of sets of parameters comprises criteria and one or more WTRU orientations associated with a receive beam of the plurality of receive beams. The method may further comprise a step of determining, a beam failure detection and recovery configuration corresponding to a second receive beam based upon a first receive beam of the plurality of receive beams and based upon a second WTRU orientation associated with the second receive beam of the plurality of receive beams based on one or more measurements; and a step of performing a beam failure detection and recovery procedure for the second receive beam based on the received criteria associated with the second receive beam and based on the second WTRU orientation.

The method may comprise a step of transmitting information indicating the received criteria associated with the second receive beam.

The WTRU may comprise an antenna panel and the WTRU orientation may be associated with the receive beams formed by the antenna panel. The received criteria of each set of parameters of the plurality of sets of parameters may be based on any of instances of beam failure counter and on beam failure detection period of time.

The one or more measurements may comprise any of rotational measurements of the WTRU. The one or more measurements may further comprise channel quality measurements.

The method may further comprise receiving information indicating rotational measurement of the WTRU from network measurements and/or from gyroscope sensor. The WTRU orientations may comprise a plurality of angle ranges.

Indicating the capability for determining WTRU orientations associated with receive beams may comprise indicating information including any of one or more parameters including number of antenna panels, angular coverage of at least one antenna panel, maximum/minimum WTRU Tx/Rx beam-width and location of the antenna panels on the WTRU. The angular coverage may include azimuth dimension and elevation dimension. The location of the antenna panels on the WTRU may be relative to the antenna panel used for transmitting the information to the network. The location of the antenna panels on the WTRU may include information indicating absolute location relative to the WTRU center.

The information indicating the capability may be sent using radio resource control uplink message. The information indicating the capability is sent using uplink control information over a control channel. Each set of parameters of the plurality of sets of parameters comprises a configuration identifier.

The method may further comprise receiving information indicating configuration for transmission of multiple SRS, and transmitting the indicated SRS through different WTRU beams as per the received configuration.

In an embodiment, a WTRU comprising a processor, a transceiver unit and a storage unit, may be configured to: send, to a network, information indicating a capability for determining WTRU orientations associated with receive beams; receive information indicating a plurality of sets of parameters associated with beam failure detection and recovery procedure, wherein the plurality of sets of parameters are associated with a plurality of receive beams, respectively, and wherein each set of parameters of the plurality of sets of parameters comprises criteria and one or more WTRU orientations associated with a receive beam of the plurality of receive beams; determine, a beam failure detection and recovery configuration corresponding to a second receive beam based upon a first receive beam of the plurality of receive beams and based upon a second WTRU orientation associated with the second receive beam of the plurality of receive beams based on one or more measurements; and perform a beam failure detection and recovery procedure for the second receive beam based on the received criteria associated with the second receive beam and based on the second WTRU orientation.

The WTRU may be configured to transmit information indicating the received criteria associated with the second receive beam.

The WTRU may comprise an antenna panel and wherein the WTRU orientation is associated with the receive beams formed by the antenna panel.

The received criteria of each set of parameters of the plurality of sets of parameters are based on any of instances of beam failure counter and on beam failure detection period of time.

The one or more measurements comprise rotational measurements of the WTRU. The one or more measurements may further comprise channel quality measurements.

The WTRU may be further configured to receive information indicating rotational measurement of the WTRU from network measurements and/or from gyroscope sensor. The WTRU orientations may comprise a plurality of angle ranges.

Indicating the capability for determining WTRU orientations associated with receive beams may comprise indicating information including any of any of one or more parameters including number of antenna panels, angular coverage of at least one antenna panel, maximum/minimum WTRU Tx/Rx beam-width and location of the antenna panels on the WTRU. The angular coverage may include azimuth dimension and elevation dimension.

The location of the antenna panels on the WTRU may be relative to the antenna panel used for transmitting the information to the network.

The location of the antenna panels on the WTRU may include information indicating absolute location relative to the WTRU center.

The information indicating the capability may be sent using radio resource control uplink message. The information indicating the capability may be sent using uplink control information over a control channel.

Each set of parameters of the plurality of sets of parameters may comprise a configuration identifier.

The WTRU may be further configured to receive information indicating configuration for transmission of multiple SRS, and to transmit the indicated SRS through different WTRU beams as per the received configuration.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a sequence diagram illustrating an example of an Intra-new-radio (NR) inter-gNB handover;

FIG. 3 is a sequence diagram illustrating an example of an Intra-NR RAN conditional Handover;

FIG. 4 is a diagram illustrating an example of parallel running procedures of a WTRU after a rotation or a blockage event;

FIG. 5 is a diagram illustrating an example of a cell coverage with different gain beams;

FIG. 6 is a system diagram illustrating an example of the impact of WTRU rotation/orientation on its field of view;

FIG. 7 is a diagram illustrating an example of WTRU rotation and its impact on the WTRU beam selection;

FIG. 8 is a system diagram illustrating an example of edge beams of a WTRU;

FIG. 9 is a system diagram illustrating an example of a method performed by a WTRU to support conditional handover (CHO) procedure;

FIG. 10 is a system diagram illustrating an example of a WTRU Tx/Rx beam based beam failure detection procedure;

FIG. 11 is a diagram illustrating an example of a simulation performance of four techniques for high directional systems communication improvement;

FIG. 12 is a system diagram illustrating an example of using antenna panel measurements to enable faster inter-cell handover;

FIG. 13 is a flow chart illustrating an example of a method, performed by a WTRU, for antenna panel selection/switching based on network reporting;

FIG. 14 is a flow chart illustrating an example of a method, performed by a WTRU, for antenna panel selection/switching based on WTRU measurements; and

FIG. 15 is a flow chart illustrating an example of a method, performed by a WTRU, for performing beam failure and detection recovery.

### DETAILED DESCRIPTION

In the following detailed description, numerous specific details are set forth to provide a thorough understanding of embodiments and/or examples disclosed herein. It will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

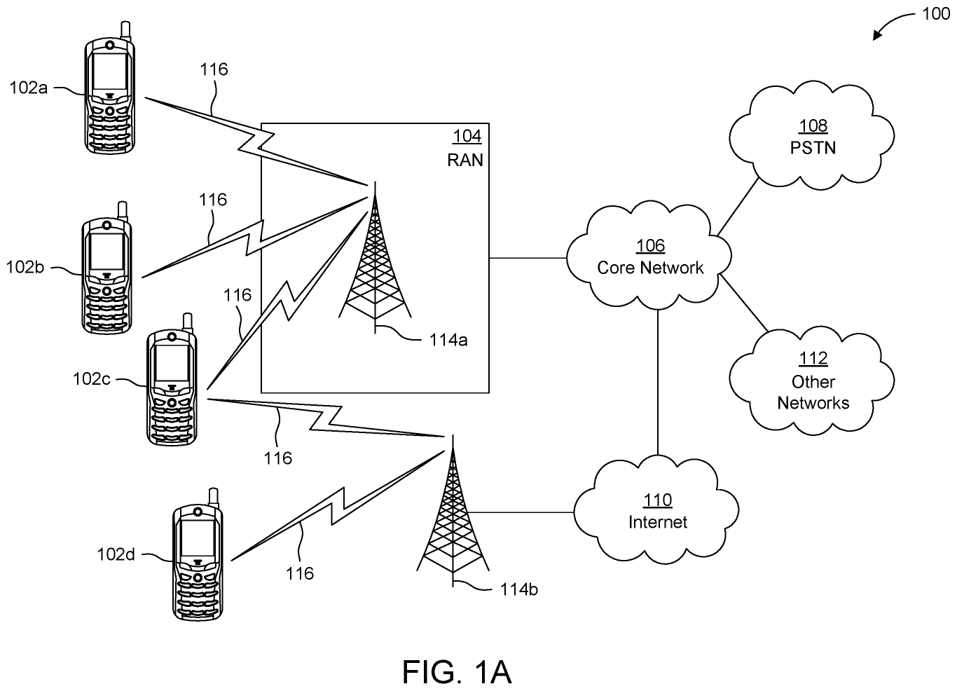

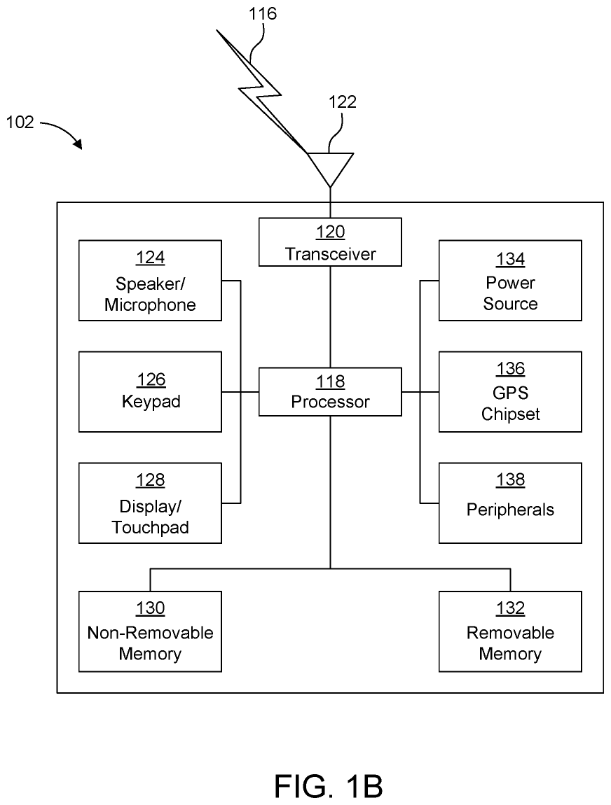

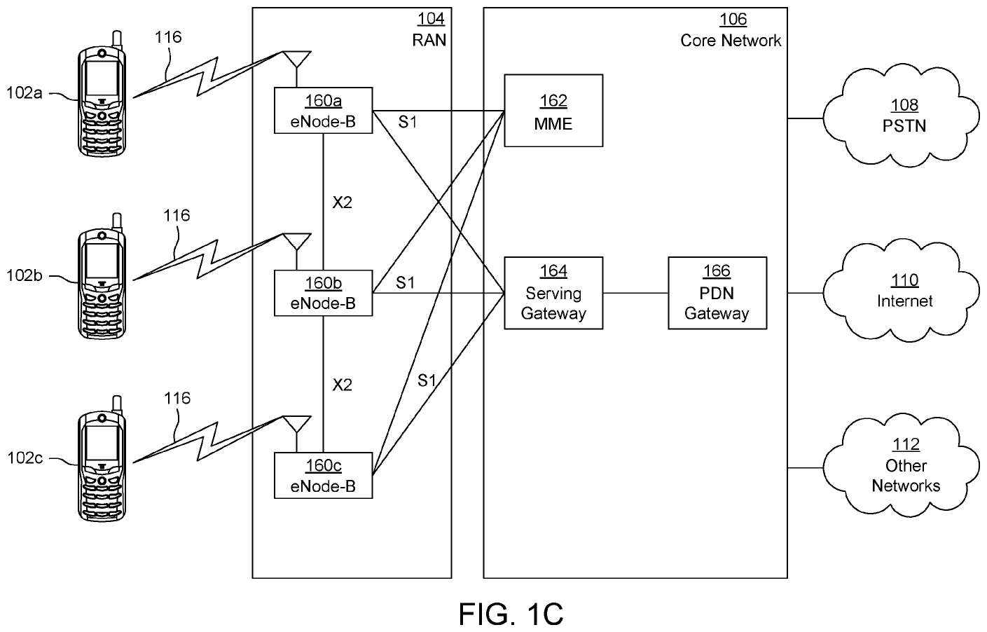

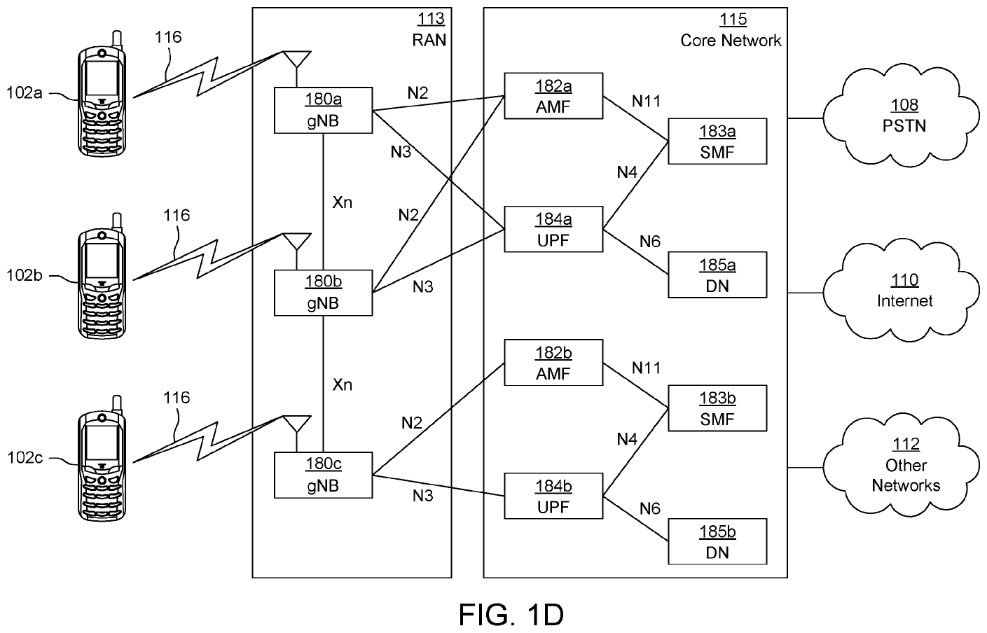

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. In one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

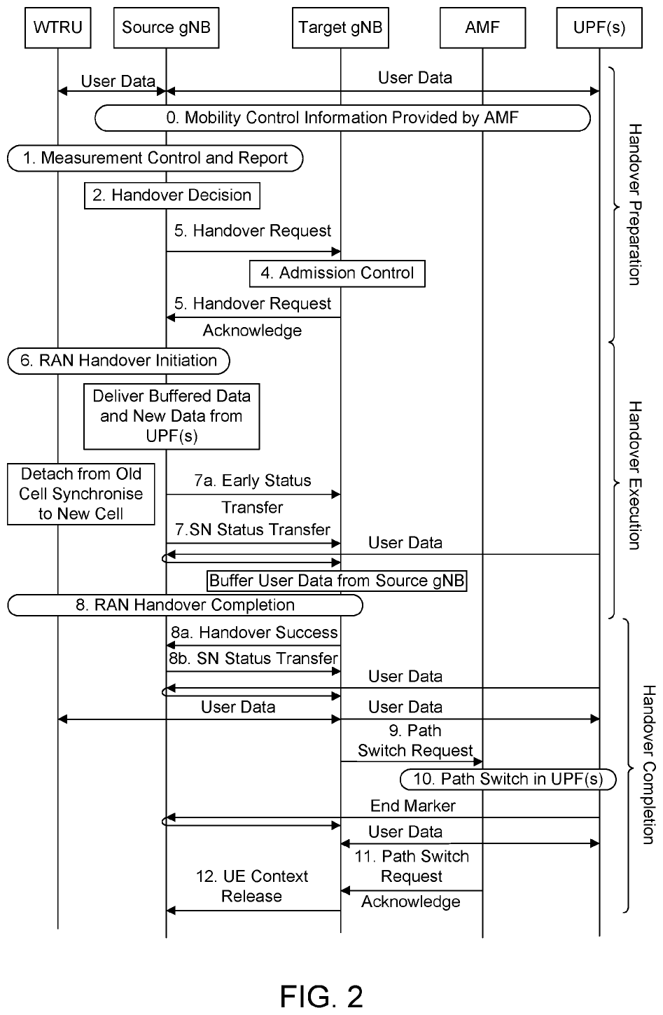

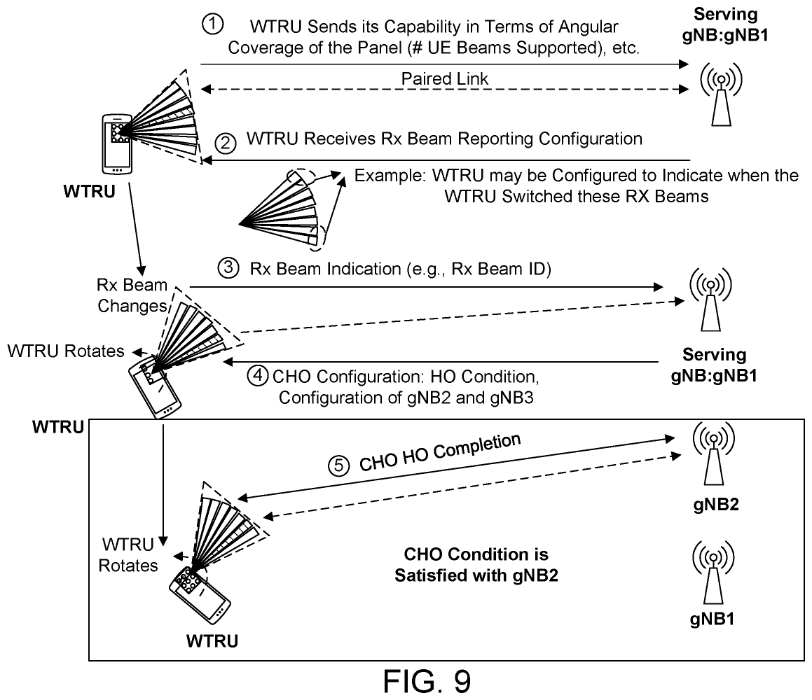

NR Inter-gNB Handover procedure is referred to herein as legacy handover. When a WTRU is in radio resource control (RRC) connected mode, cell/gNB level mobility may require explicit RRC signaling to be triggered. The WTRU may report the cell quality measurement to its serving (e.g., source) cell when a neighboring cell quality is offset better for a preset duration of time-to-trigger (TTT). Referring to “NR and NG-RAN Overall description; Stage-2, 3rd Generation Partnership Project (3GPP) Technical Specification (TS) 38.300, December 2021, v16.8.0”, different events called A1, A2, A3, A4, A5, etc. may be defined for WTRU measurement report triggering. The TTT and the cell specific offsets may be specified during the measurement configuration step. If a handover (HO) decision is made based on the measurement report, the source gNB may issue a handover request to the target gNB. If the WTRU is admitted by the target gNB, the target gNB may send a handover request acknowledgement to the source gNB, which contains an RRC message to be sent to the WTRU. Next, the source gNB may initiate handover and may send the RRC reconfiguration message to the WTRU. It may also include a set of dedicated random-access channel (RACH) resources. Finally, the WTRU may synchronize to the target cell and completes the RRC handover procedure. The overall handover (HO) procedure is illustrated in FIG. 2. FIG. 2 is extracted from FIG. 9.2.3.2.1-1 of document 3GPP TS 38.300 version 16.4.0 Release 16.

Referring to FIG. 2, at step 0, the WTRU context within the source gNB may contain information regarding roaming and access restrictions which were provided either at connection establishment or at the last TA update.

At step 1, the source gNB may configure the WTRU measurement procedures and the WTRU may report according to the measurement configuration.

At step 2, the source gNB may decide to handover the WTRU, based on MeasurementReport and RRM information.

At step 3, the source gNB may issue a Handover Request message to the target gNB passing a transparent RRC container with necessary information to prepare the handover at the target side. The information may include at least the target cell ID, KgNB, the C-RNTI of the WTRU in the source gNB, RRM-configuration including WTRU inactive time, basic AS-configuration including antenna Info and DL Carrier Frequency, the current QoS flow to DRB mapping rules applied to the WTRU, the SIBI from source gNB, the WTRU capabilities for different RATs, PDU session related information, and can include the WTRU reported measurement information including beam-related information if available. The PDU session related information may include the slice information and QoS flow level QoS profile(s). The source gNB may also request a DAPS handover for one or more DRBs.

After issuing a Handover Request, the source gNB may not reconfigure the WTRU, including performing Reflective QoS flow to DRB mapping.

At step 4, admission Control may be performed by the target gNB. Slice-aware admission control may be performed if the slice information is sent to the target gNB. If the PDU sessions are associated with non-supported slices, the target gNB may reject such PDU Sessions.

At step 5, the target gNB may prepare the handover with L1/L2 and sends the HANDOVER REQUEST ACKNOWLEDGE to the source gNB, which may include a transparent container to be sent to the WTRU as an RRC message to perform the handover. The target gNB may indicate if a DAPS handover is accepted. As soon as the source gNB receives the HANDOVER REQUEST ACKNOWLEDGE, or as soon as the transmission of the handover command is initiated in the downlink, data forwarding may be initiated. For DRBs configured with DAPS, downlink PDCP SDUs may be forwarded with SN assigned by the source gNB, until SN assignment is handed over to the target gNB in step 8b, for which the normal data forwarding follows as defined in 9.2.3.2.3 of document 3GPP TS 38.300 version 16.4.0 Release 16.

At step 6, the source gNB may triggers the Uu handover by sending an RRCReconfiguration message to the WTRU, containing the information required to access the target cell: at least the target cell ID, the new C-RNTI, the target gNB security algorithm identifiers for the selected security algorithms. It may also include a set of dedicated RACH resources, the association between RACH resources and SSB(s), the association between RACH resources and WTRU-specific CSI-RS configuration(s), common RACH resources, and system information of the target cell, etc. For DRBs configured with DAPS, the source gNB may not stop transmitting downlink packets until it receives the HANDOVER SUCCESS message from the target gNB in step 8a. CHO cannot be configured simultaneously with DAPS handover. At step 7a, for DRBs configured with DAPS, the source gNB may send the EARLY STATUS TRANSFER message. The DL COUNT value conveyed in the EARLY STATUS TRANSFER message may indicate PDCP SN and HFN of the first PDCP SDU that the source gNB forwards to the target gNB. The source gNB may not stop assigning SNs to downlink PDCP SDUs until it sends the SN STATUS TRANSFER message to the target gNB in step 8b.

At step 7, for DRBs not configured with DAPS, the source gNB may send the SN STATUS TRANSFER message to the target gNB to convey the uplink PDCP SN receiver status and the downlink PDCP SN transmitter status of DRBs for which PDCP status preservation applies (i.e., for RLC AM). The uplink PDCP SN receiver status may include at least the PDCP SN of the first missing UL PDCP SDU and may include a bit map of the receive status of the out of sequence UL PDCP SDUs that the WTRU may need to retransmit in the target cell, if any. The downlink PDCP SN transmitter status may indicate the next PDCP SN that the target gNB shall assign to new PDCP SDUs, not having a PDCP SN yet. In case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7. For DRBs configured with DAPS, the source gNB may additionally send the EARLY STATUS TRANSFER message(s) between step 7 and step 8b, to inform discarding of already forwarded PDCP SDUs. The target gNB may not transmit forwarded downlink PDCP SDUs to the WTRU, whose COUNT is less than the conveyed DL COUNT value and discards them if transmission has not been attempted already.

At step 8, the WTRU may synchronise to the target cell and completes the RRC handover procedure by sending RRCReconfigurationComplete message to target gNB. In case of DAPS handover, the WTRU may not detach from the source cell upon receiving the RRCReconfiguration message. The WTRU may release the source SRB resources, security configuration of the source cell and stops DL/UL reception/transmission with the source upon receiving an explicit release from the target node. From RAN point of view, the DAPS handover may be considered to only be completed after the WTRU has released the source cell as explicitly requested from the target node. RRC may suspend, a subsequent handover or inter-RAT handover may not be initiated until the source cell has been released.

At step 8a/b, in case of DAPS handover, the target gNB may send the HANDOVER SUCCESS message to the source gNB to inform that the WTRU has successfully accessed the target cell. In return, the source gNB may send the SN STATUS TRANSFER message for DRBs configured with DAPS for which the description in step 7 applies, and the normal data forwarding follows as defined in 9.2.3.2.3 of document 3GPP TS 38.300 version 16.4.0 Release 16. The uplink PDCP SN receiver status and the downlink PDCP SN transmitter status may be also conveyed for DRBs with RLC-UM in the SN STATUS TRANSFER message in step 8b, if configured with DAPS. For DRBs configured with DAPS, the source gNB may not stop delivering uplink QoS flows to the UPF until it sends the SN STATUS TRANSFER message in step 8b. The target gNB may not forward QoS flows of the uplink PDCP SDUs successfully received in-sequence to the UPF until it receives the SN STATUS TRANSFER message, in which UL HFN and the first missing SN in the uplink PDCP SN receiver status indicates the start of uplink PDCP SDUs to be delivered to the UPF. The target gNB may not deliver any uplink PDCP SDUs which has an UL COUNT lower than the provided.

At step 9, the target gNB may send a PATH SWITCH REQUEST message to AMF to trigger 5GC to switch the DL data path towards the target gNB and to establish an NG-C interface instance towards the target gNB.

At step 10, 5GC may switch the DL data path towards the target gNB. The UPF may send one or more “end marker” packets on the old path to the source gNB per PDU session/tunnel and then can release any U-plane/TNL resources towards the source gNB.

At step 11, the AMF may confirm the PATH SWITCH REQUEST message with the PATH SWITCH REQUEST ACKNOWLEDGE message.

At step 12, upon reception of the PATH SWITCH REQUEST ACKNOWLEDGE message from the AMF, the target gNB may send the WTRU CONTEXT RELEASE to inform the source gNB about the success of the handover. The source gNB may then release radio and C-plane related resources associated to the WTRU context. Any ongoing data forwarding may continue. The RRM configuration may include both beam measurement information (for layer 3 mobility) associated to SSB(s) and CSI-RS(s) for the reported cell(s) if both types of measurements are available. Also, if CA is configured, the RRM configuration may include the list of best cells on each frequency for which measurement information is available. And the RRM measurement information may also include the beam measurement for the listed cells that belong to the target gNB. The common RACH configuration for beams in the target cell may be only associated to the SSB(s). The network may have dedicated RACH configurations associated to the SSB(s) and/or have dedicated RACH configurations associated to CSI-RS(s) within a cell. The target gNB may only include one of the following RACH configurations in the Handover Command to enable the WTRU to access the target cell: i) Common RACH configuration; ii) Common RACH configuration+Dedicated RACH configuration associated with SSB; iii) Common RACH configuration+Dedicated RACH configuration associated with CSI-RS. The dedicated RACH configuration may allocate RACH resource(s) together with a quality threshold to use them. When dedicated RACH resources are provided, they may be prioritized by the WTRU and the WTRU may not switch to contention-based RACH resources as long as the quality threshold of those dedicated resources is met. The order to access the dedicated RACH resources may be up to WTRU implementation. Upon receiving a handover command requesting DAPS handover, the WTRU may suspend source cell SRBs, stops sending and receiving any RRC control plane signalling toward the source cell, and establishes SRBs for the target cell. The WTRU may release the source cell SRBs configuration upon receiving source cell release indication from the target cell after successful DAPS handover execution. When DAPS handover to the target cell fails and if the source cell link is available, then the WTRU may revert back to the source cell configuration and resumes source cell SRBs for control plane signalling transmission.

The HO process may fail due to poor channel qualities of the target gNB, the source gNB or both. In a scenario with directional links, handover problems are exacerbated because the link qualities of the target and source gNBs may suddenly deteriorate due to mobile blockers or WTRU rotations. First, the blockage of target gNB during a handover procedure may result in a handover failure (HOF). When the WTRU receives RRC Reconfiguration message, a handover failure timer T304 may be started. If the T304 timer expires before the handover is completed, a HOF may be declared, and the WTRU may perform connection re-establishment. Second, after a sudden WTRU rotation or a blockage, the source gNB may not be able to initiate a handover procedure in time based on the most recent measurement reports. Even the measurement reports from the WTRU may be lost due to poor link quality. Thus, without handover assistance from the source gNB, even when there are potential target gNBs with good channel qualities, the WTRU may need to either wait for the source gNB to recover from outage or declare a radio link failure (RLF)

As a potential solution to the target gNB being blocked, dual-active protocol stack (DAPS) handover was specified in 3GPP Rel. 16. In DAPS handover, the WTRU may not release the source cell connection until random access to the target gNB is completed. If the target gNB link deteriorates before random access is completed, the WTRU may fall back to the source gNB.

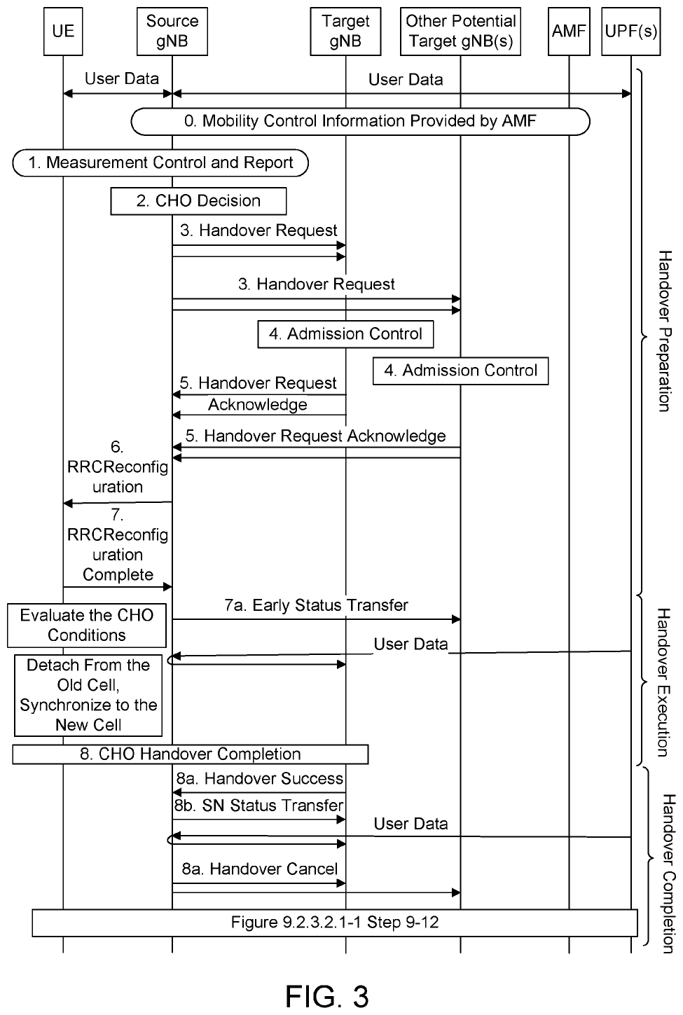

To address the blockage of the source gNB, conditional handover (CHO) was specified in 3GPP Rel. 16. In CHO, the WTRU may be configured to execute handover when one or more handover execution conditions are met. The source gNB may proactively configure the WTRU to evaluate CHO execution conditions defined for candidate gNBs. Once the conditions are met, e.g., when the target gNB is an offset better than the source gNB, the WTRU may initiate handover to a target gNB without the signaling from the source gNB. Thus, even when the source gNB is in outage state due to a sudden blockage or a rotation, the WTRU may still successfully complete a handover with the target gNB if a CHO execution condition is satisfied. The overall CHO procedure is illustrated in FIG. 3. FIG. 3 is extracted from FIG. 9.2.3.4.2-1 of document 3GPP TS 38.300 version 16.4.0 Release 16.

Referring to FIG. 3, step 0 and step 1 are similar than step 0 and step 1 of FIG. 2.

At step 2, the source gNB may decide to use CHO.

At step 3, the source gNB may request CHO for one or more candidate cells belonging to one or more candidate gNBs. A CHO request message may be sent for each candidate cell.

Step 4 is similar than FIG. 2

At step 5, the candidate gNB(s) may send CHO response (HO REQUEST ACKNOWLEDGE) including configuration of CHO candidate cell(s) to the source gNB. The CHO response message may be sent for each candidate cell.

At step 6, the source gNB may send an RRCReconfiguration message to the WTRU, containing the configuration of CHO candidate cell(s) and CHO execution condition(s). CHO configuration of candidate cells may be followed by other reconfiguration from the source gNB. A configuration of a CHO candidate cell may not contain a DAPS handover configuration.

At step 7, the WTRU may send an RRCReconfigurationComplete message to the source gNB.

At step 7a, if early data forwarding is applied, the source gNB may send the EARLY STATUS TRANSFER message.

At step 8, the WTRU may maintain connection with the source gNB after receiving CHO configuration, and starts evaluating the CHO execution conditions for the candidate cell(s). If at least one CHO candidate cell satisfies the corresponding CHO execution condition, the WTRU may detach from the source gNB, may apply the stored corresponding configuration for that selected candidate cell, may synchronise to that candidate cell and completes the RRC handover procedure by sending RRCReconfigurationComplete message to the target gNB. The WTRU may release stored CHO configurations after successful completion of RRC handover procedure.

At step 8a/b, the target gNB may send the HANDOVER SUCCESS message to the source gNB to inform that the WTRU has successfully accessed the target cell. In return, the source gNB may send the SN STATUS TRANSFER message following the principles described in step 7 of FIG. 2. Late data forwarding may be initiated as soon as the source gNB receives the HANDOVER SUCCESS message.

At step 8c, the source gNB may send the HANDOVER CANCEL message toward the other signalling connections or other candidate target gNBs, if any, to cancel CHO for the WTRU. Step 9 to Step 12 are similar than FIG. 2.

Although CHO may be resilient to mobile blockers and may significantly reduce the number of RLFs, its success may depend on the availability of candidate gNBs before the blocker arrival, the link quality of the corresponding links, as well as the condition thresholds for the target gNBs. Even if there are candidate gNBs, the WTRU may need to be able to maintain the link quality with the selected candidate gNB until the handover completion. Furthermore, a careful configuration of the condition thresholds for the handover execution may be also needed. Higher threshold values may lead to the WTRU often failing to timely execute handover to a target gNB leading to a higher number of failed handovers. On the other hand, lower threshold values may lead to a sub-optimal choice of a new serving gNB.

The WTRU may performs radio link monitoring (RLM) based on the synchronization signal block (SSB) or/and the channel state information reference signals (CSI-RS), and the signal quality thresholds configured by the network.

The criteria to declare RLF are listed in document “NR; Radio Resource Control (RRC); Protocol specification, 3rd Generation Partnership Project (3GPP) Technical Specification (TS) 38.331, December 2021, v16.7.1.”, including the following criteria relevant to our discussion:

T310 based RLF: Based on the link quality measurements (using SSBs or/and CSI-RSs), if consecutive out-of-sync indications (e.g., measurement is below the given threshold) are received a preset times, N310 times, the RLF timer T310 may be started. If the channel quality recovers before the T310 timer expires, the T310 timer may be reset; otherwise, upon expiration of the T310 timer, an RLF may be declared.

T312 based RLF: The WTRU may start the T312 timer upon triggering a measurement report for which the T310 timer is already running. The T312 timer may allow the WTRU to differentiate between an RLF caused by a handover failure or an RLF caused by coverage hole. The T312 timer may be (e.g., typically) shorter than the T310 timer. Thus, if the channel quality of the source gNB is worse than a threshold, the shorter T312 timer may expire earlier and an RLF may be timely declared.

Random access procedure failure: If multiple RACH attempts to connect to a gNB fail consecutively, an RLF may be declared.

In frequency range 2 (FR2), beam level measurements and beam management may be integral for achieving high-capacity channels. The best beam pair may be continuously updated as the system changes due to WTRU movements and mobile blockers. A mobile blocker and/or

WTRU rotations may lead to rapid degradation of the current beam pair without sufficient time for the regular beam to adapt. In this scenario, the WTRU may detect the beam failure and may initiate a beam recovery process. The WTRU may declare a beam failure if the number of beam failure indications reach a configured threshold, beamFailureInstanceMaxCount, before a configured timer, beamFailureDetectionTimer, expires. After a beam failure, the WTRU may start a random access procedure using the configured candidate beams and preambles. If the WTRU may not synchronize with the gNB after multiple RACH attempts, an RLF may be declared.

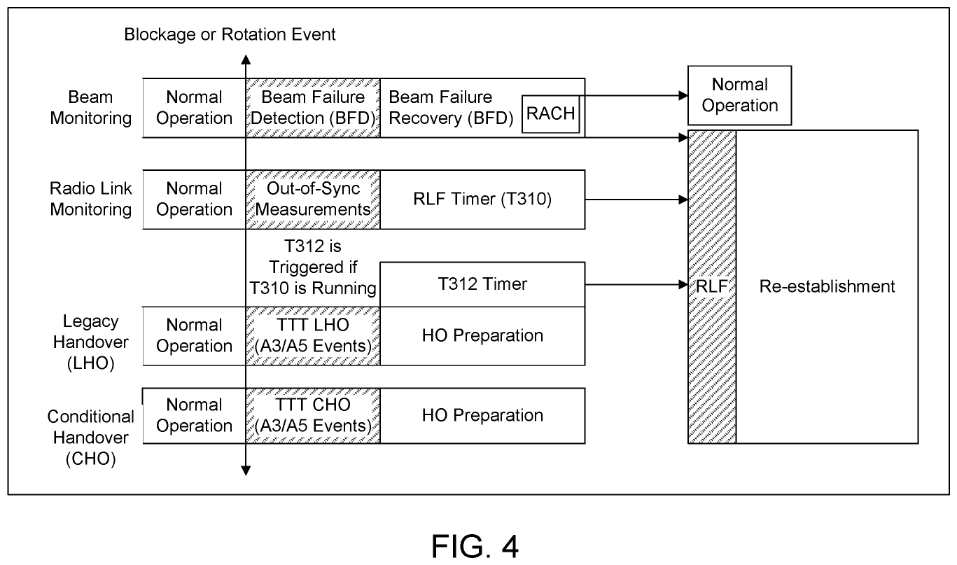

After a blockage or rotation event, the BFDR, RLM, and handover procedures may run concurrently, as illustrated FIG. 4. FIG. 4 depicts an example of parallel running procedures after a rotation of the WTRU or a blockage event. Referring to FIG. 4, each individual procedure (e.g., beam monitoring, radio link monitoring, legacy handover, conditional handover) may lead to an RLF. When the WTRU is configured to use legacy HO, the link outage may interrupt the measurement reporting and/or HO initiation. The HO operation may fail. In parallel, the BFDR procedure may attempt to recover through BFR. If the recovery attempts fail, an RLF may be declared by the BFDR procedure. When the WTRU is configured to use CHO, once a mobile blocker obstructs the link with the source gNB, the CHO conditions may be satisfied and the WTRU may initiate CHO to another gNB within its field of view (FoV).

Serving gNB and source gNB are be used interchangeably herein. Random access and RACH are be used interchangeably herein. WTRU beam, WTRU Tx/Rx beam, WTRU Rx beam, and WTRU Tx beam are used interchangeably herein with the assumption of beam correspondence capability at the WTRU.

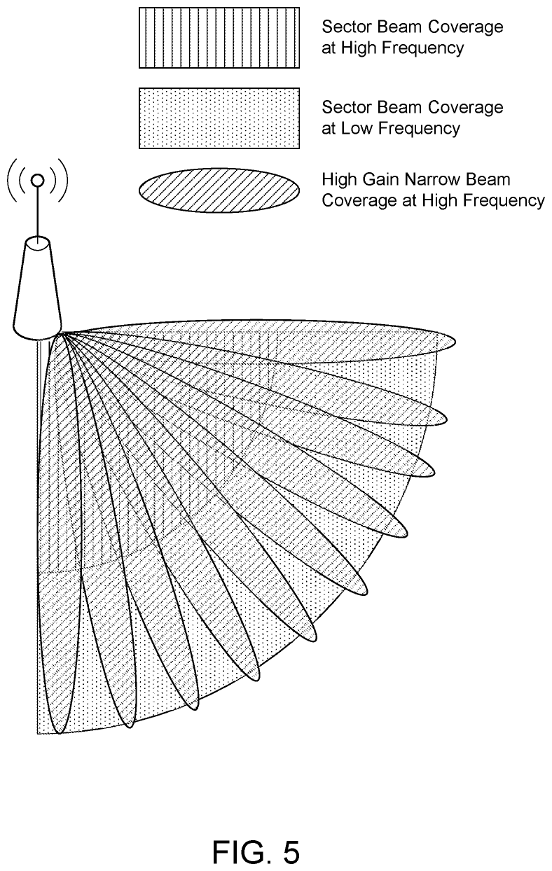

Propagation at higher frequency bands may be more challenging issue than the lower frequency bands. High propagation loss at higher frequencies may necessitate the use of high antenna-gain with narrow beam based directional (e.g., beamformed) transmissions. To increase the antenna-gain over a wide sector beam, larger antenna arrays (e.g., number of antenna elements ranging from tens to hundreds) may be used to form high gain beams. An example of effect on coverage and the compensation of path loss by using narrow beams at higher frequency is illustrated at FIG. 5. FIG. 5 depicts an example of cell coverage with different gain beam. Referring to FIG. 5, in such directional systems, since the spatial coverage for each Tx beam is limited, multiple beams would be needed for transmitting DL common channels (e.g., system information, paging, etc.) to cover the entire cell area. Number of concurrent high gain beams that a gNB may support, may be limited by the cost and complexity of the utilized transceiver architecture.

As the carrier frequency increases, the number of beams required to cover the entire cell increases due to the higher beamforming gain required to overcome propagation loss limitations. As shown in Table 1, a link budget analysis is performed to estimate the number of beams required to cover a sector of +/−45 degree for multiple coverage ranges at different millimeter wave carrier frequencies. As the carrier frequency increases, the number of required beams required to cover the sector increases significantly. Table 1 depicts an example of a link budget analysis showing the number of beams and the number of antennas elements required at different carrier frequencies.

TABLE 1
Link Budget Analysis
Link-Budget Analysis
num of beams (N), num antenna elements (M)

| | 28 GHz | 60 GHz | 114 GHz | 140 GHz |
|---|---|---|---|---|
| Range = 10 m | N = 9 | N = 25 | N = 81 | N = 100 |
| | M = 5 | M = 12 | M = 32 | M = 36 |
| Range = 50 m | N = 49 | N = 144 | N = 324 | N = 400 |
| | M = 20 | M = 49 | M = 132 | M = 144 |

Steerable range: +/−45deg in elevation and azimuth, min SNR = 18 dB for 16QAM

At higher frequencies (e.g., sub-THz bands), due to high attenuation and path loss, larger antenna arrays (e.g., number of antenna elements ranging from tens to hundreds) may be used to form high gain and narrower beams, e.g., directional transmissions, and may be needed to increase the coverage distance. As we move higher in the frequencies, the beams may become narrower (e.g., almost “laser-like” beams) and number of beams used by a base station (e.g., gNB) to cover its coverage area may be expected to be much higher than the NR system operating at mmWave frequencies (e.g., below 71 GHz bands). Highly directional links resulting from narrower beams at both WTRU and gNB may be much more sensitive to dynamic environments compared to the conventional links. One cause of such dynamic environments may be the WTRU rotations which created from rotational movements of handset/wearable devices such as smartphone, gaming, and VR/XR headsets, etc. These movements may originate from hand gestures, head movements etc. The WTRU rotations may lead to channel variations between the serving gNB and the WTRU which may cause beam misalignment or even link/connection failures.

Antenna arrays/panels with large number of antennas required to facilitate directional links at higher frequencies may generally have limited angular coverage, for example, less than 360-degree coverage. This limitation may come the way these antennas/panels are implemented at different devices, and the nature/style of these devices.

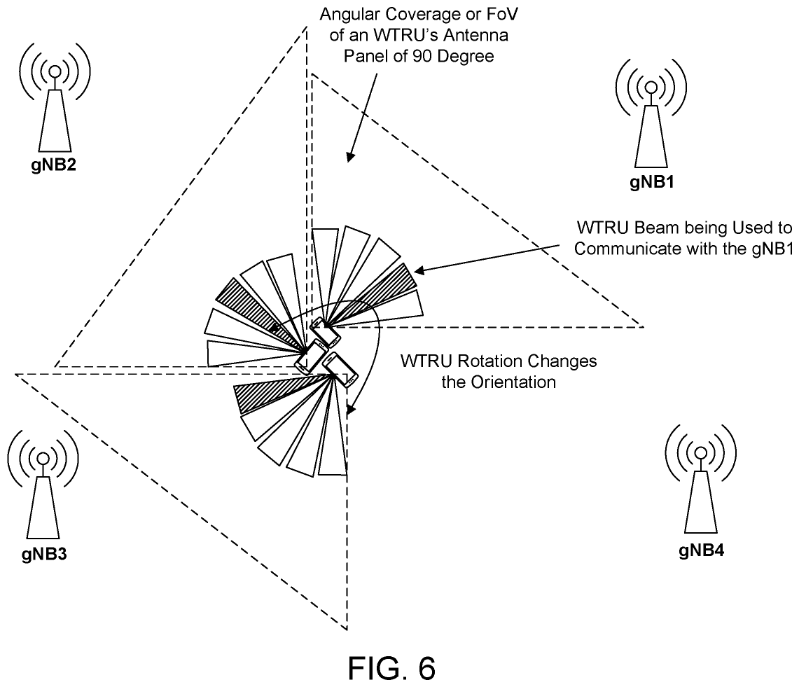

A WTRU with a limited number of antenna array panels may have limited angular coverage. Rapid changes in WTRU orientation due to rotations may incur sudden outages with the serving/source gNB, and the WTRU may not have a configuration to handover to a new gNB which may be the best suited for establishing a connection with the WTRU's updated angular coverage after the rotation. This may incur a long outage for the WTRU. An example of a rotating single antenna panel WTRU is shown in FIG. 6, where due to the limited angular coverage (of 90 degree) of the panel, the WTRU sees different gNBs when its orientation is different. FIG. 6 depicts an example of the impact of a WTRU rotation/orientation on its field of view.

Delay in cell reselections and handover using existing Layer 1/Layer 2 and Layer 3 based mobility procedures may significantly increase the outage duration. For the WTRUs equipped with multiple antenna panels, the situation may be better compared to the single antenna panel WTRUs. Nevertheless, multi-panel devices may have to be equipped with multiple transceivers to effectively increase their angular coverage beyond a single antenna panel WTRU. The presence of multiple antenna panels and multiple transceivers adds significant cost and footprint to the devices, and many hand-held devices and wearable devices may have limited capabilities to stay competitive in terms of cost and footprint.

The term field of view (FoV) is used herein to represent the angular coverage or angular range of an antenna panel for a given orientation. Depending on the WTRU orientation and the angular coverage of the antenna, the WTRU may be limited to communicate with the gNBs lie in the field of view provided by the antenna panel at that time. In case of non-line-of-sight communication, there can gNBs lie outside of the WTRU's FOV with which the communication link can be established. WTRU may have single or multiple antenna panels. More antenna panels and more transceivers extend the field of view-nevertheless limited available transceivers limit the capabilities nonetheless.

The FoV may more suitably be attributed to an antenna panel rather than a WTRU. In that case, even multi-panel WTRUs have different FoVs for different antenna panels. Despite the presence of multiple panels, there are many physical and environmental limitations that may limit a WTRU's FoV to the FoV of a single antenna panel or FoV of limited number of antenna panels. The limitations in terms of available transceiver chains limit the use of antenna panels for simultaneous use. This may also require regular measurement gaps in different directions, and potential switch off from the main serving beam/cell to make those measurements. Applications with demanding QoS requirements may limit the feasibility of timely measurements from non-FoV directions as it may not be possible to introduce regular gaps with respect to the data flows from the serving beam/cell. As a result, FoV limitations may get aggravated despite the presence of multiple antenna panels at devices. A variety of IoT kind of devices may have FoV limitation kicking in due to power consumption reasons where it may be power inefficient for such devices to keep making measurements on neighboring beams/cells.

A WTRU may be configured to send information (e.g., explicit) about its orientation to the network (e.g., serving gNB). Using the WTRU orientation information, the network (e.g., serving gNB) may provide the WTRU with configuration of CHO. The network may use the WTRU orientation information to determine (e.g., predict) the potential (e.g., neighboring) gNBs to be configured for the CHO. The WTRU may use the given CHO configuration to perform handover.

A WTRU may be configured to send information to the network (e.g., serving gNB) about its capability (e.g., WTRU capability) containing one or more of the parameters including number of antenna panels, (e.g., maximum) angular coverage of each antenna panel, maximum/minimum WTRU Tx/Rx beam-width (e.g., 3 dB or half power beam width), location of the antenna panels on the device, etc. The total number of beams which may be formed within the antenna panel's FoV may be provided in the WTRU capability information or this may be derived using the beam-width and the angular coverage information. Angular coverage information in both azimuth and elevation dimension may be provided to the network. The location of (e.g., other) antenna panels (e.g., 2D or 3D coordinates) may be provided relative to the antenna panel being used/selected to communicate with the network (e.g., serving gNB). Alternatively, absolute location relative to the device center in terms of 2D or 3D coordinates or in terms of named direction such as north, south-east, etc. may be provided. The WTRU capability information may be sent using higher layer signaling (e.g., RRC uplink message). In an embodiment, the WTRU capability information may be sent as uplink control information over the control channel (e.g., Physical Uplink Control Channel (PUCCH)) or over the data channel (e.g., Physical Uplink Data Channel (PUSCH)).

The WTRU may use one of the antenna panels (e.g., the antenna panel with which the channel quality between the WTRU and the gNB is above a threshold) to communicate with the network (e.g., serving/source gNB). Any (e.g., each) antenna panel may be able to form one or more Tx or/and Rx beams in one or more direction of the communication. Based on the WTRU orientation, the WTRU may use or select a Tx/Rx WTRU beam to communicate with the network (e.g., serving/source gNB). The selection may be based on the Tx/Rx beam training/measurement procedure. For example, the WTRU may select a Tx/Rx WTRU beam which provides the best communication link (e.g., channel quality is above a minimum threshold) between the WTRU and the network (e.g., serving gNB). A change in the WTRU orientation due to WTRU rotation may require change in the Tx/Rx WTRU beam.

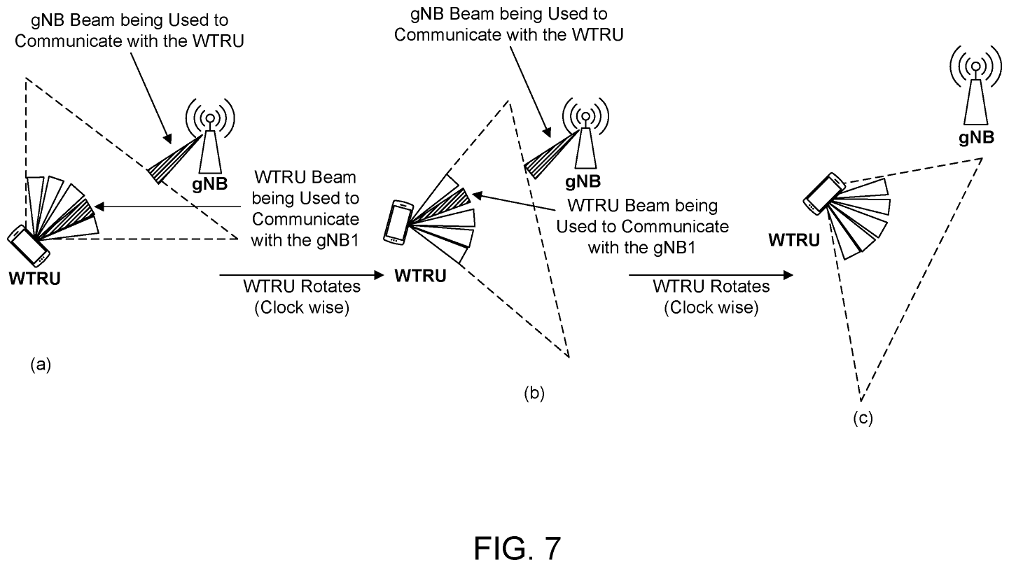

FIG. 7 depicts an example of WTRU rotation and its impact on the WTRU beam selection. Referring to FIG. 7, step (a) and step (b), after a WTRU rotation, from (a) to (b), the WTRU may use a different beam to communicate with the gNB. As a non-limited example, the WTRU may keep track of the device orientation or rotation angle, for example, using available/configured measurements by the network or using gyroscope sensors, and may use the appropriate Tx/Rx WTRU beam to communicate with the network (e.g., serving gNB). There may not be any change in the gNB beam due to WTRU rotations, as shown in the FIG. 7, step (a) and step (b).

As illustrated by FIG. 7, step (c), after a large rotation (e.g., rotation higher than a rotation threshold), the serving gNB may be out of the FoV of the antenna panel which is being used/selected to communicate with the serving/source gNB. There may be scenarios, when the other gNBs may be out of the FoV of the WTRU antenna panel when the WTRU is communicating with the serving/source gNB. An example is shown in FIG. 6 for a single antenna panel WTRU with angular coverage of 90 degree and where the gNBs are deployed as shown in the figure. In such exemplary scenario, at any given point, the WTRU may have only one gNB in its FoV, hence may not make measurements with the neighboring gNBs. Without such measurements, the serving/source gNB would not be able to configure the WTRU for the handover to neighboring target gNBs. Hence, when the WTRU rotates by a large amount (e.g., by 90 degrees in the example shown in FIG. 6), the WTRU may not be able to perform handover to the new target gNB in its FoV. In such cases, the WTRU may first need to declare the radio link failure with the (e.g., previous) serving/source gNB and then may need to discover a new gNB in its FoV for connection establishment. This may incur significant delays and outage for the WTRU.

The WTRU may be configured by the network (e.g., serving/source gNB) to report its orientation. This information may help the gNB to predict/determine the (e.g., neighboring) target gNBs for potential handover. For example, the gNB may determine the (e.g., neighboring) gNBs which may be in WTRU's FOV soon if the WTRU rotates (e.g., without using any WTRU measurements on the neighboring gNBs).

In an embodiment, the WTRU may be configured with event-based/triggered reporting. The WTRU may be configured with event-based reporting based on the event whether the WTRU is using one of the center or edge WTRU Tx/Rx beams to communicate with the serving/source gNB. As a non-limited example, an event may be triggered when the WTRU starts using one of the ‘N’ (N>=1) (e.g., edge) WTRU beams formed towards at the edge of the angular coverage or FoV provided by the antenna panel. This may be applied to both ends of the angular coverage.

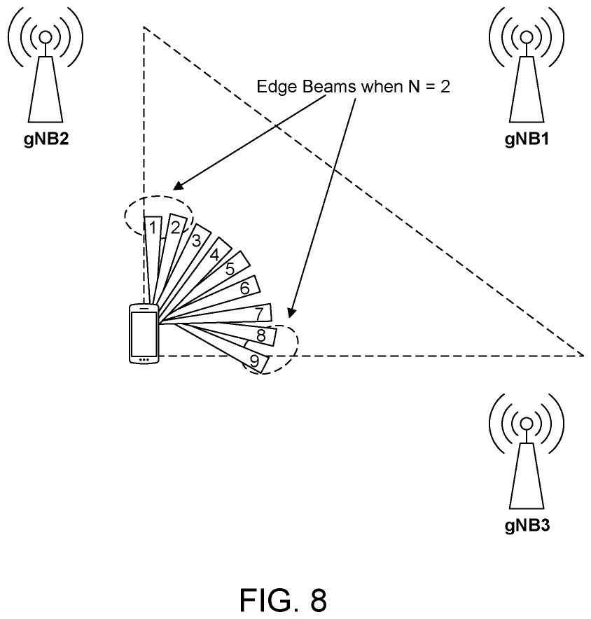

FIG. 8 depicts an example of edge beams. Referring to FIG. 8, for the case of N=2, if the WTRU uses the last two beams in either of the sides, beam 1, beam 2, beam 8, or beam 9, then the event for reporting may be triggered. Such reporting may indicate the gNB that the WTRU is at the edge of WTRU angular coverage and soon the gNB may be out of the FoV of the WTRU. In such condition the gNB may predict/determine other potential target gNBs for potential handover and may configure the WTRU with CHO with the selected target gNBs. Referring to FIG. 8, if the WTRU report is triggered because of the use of beam 1 or beam 2, the gNB1 may configure gNB3, otherwise, if the WTRU report is triggered based on the beam 8 or beam 9, the gNB 1 may configure gNB2 for the CHO.

In an embodiment, the WTRU may be configured with a time period, for example, “time-to-trigger”. The time-to-trigger may be used to trigger the report. For example, the WTRU report that indicates the use of edge beam may be triggered when for example, if one of the N edge beams is used/selected by the WTRU to communicate with the serving gNB for a minimum time duration of value time-to-trigger.

In an embodiment, a WTRU may be configured to provide its Tx/Rx beam indication to the gNB if its active Tx/Rx beam is one of the edge beams, and the channel quality measurements through this beam falls below a configured threshold. For the case of DL transmissions, this event will trigger when WTRU is receiving through one of its edge beams and the channel quality measurements on the resource associated to the DL transmission (DMRS, CSI-RS or SSB) falls below a configured RSRP threshold. Similarly different metrics of quality like RSRQ etc., may be employed. In an embodiment, reporting this event may be when the estimated quality of the reference signal (RSRP e.g.) is within a given range. This may make sense as if the signal quality becomes very bad, there are pre-defined events which will trigger with reference to hand-over configuration or radio-link-failure.

In an embodiment, the WTRU may be configured (e.g., by the network) to send one bit information in the WTRU report indicating the use of one of the configured edge beams. This one bit information may be used to indicate the edge (e.g., left or right) of the FoV being used/selected. For example, the WTRU may send ‘1’ in case of the report is triggered due to the use of one of N edge beams at left edge of the FoV (e.g., when N=2, beam 1 or beam 2 in FIG. 8), and the WTRU may send ‘0’ in case of the report is triggered due to the use of one of N edge beams at left edge of the FoV (e.g., when N=2, beam 8 or beam 9 in FIG. 8).

In another embodiment, the WTRU may be configured (e.g., by the network) to send ‘ceil (log2(N)). I’ number of bits in the WTRU report indicating the use of one of the configured edge beams. The most significant bit may be used to indicate the edge of FoV and the remaining bits may be used to indicate the beam. For example, for N=2 as shown in FIG. 8, the following indications may be used by the WTRU: 10 for beam 1, 11 for beam 2, 01 for beam 8, 01 for beam 9.

In another embodiment, the WTRU may be configured (e.g., by the network) to send (e.g., absolute) WTRU beam ID in the WTRU report. A beam indexing format/pattern may be used, for example the beam indexing may start from left most beam of FoV of the antenna panel as shown in FIG. 8. The WTRU may be configured (e.g., by the network) for the beam indexing method/format. The WTRU may be configured to send ceil (log 2 (maximum number of beams which can be formed to cover the FoV of the antenna panel)) bits in the WTRU report. For example, for N=2 as shown in FIG. 8, the following indications may be used by the WTRU: 0000 for beam 1, 0001 for beam 2, 0111 for beam 8, 1000 for beam 9.

The WTRU report may trigger due to the use of one of the configured edge beams may be sent as uplink control information (e.g., over the uplink control channel PUCCH). The WTRU may be configured with an uplink resource configuration to send a report. The configuration may include at least one of: periodicity, time offset, prohibit timer, uplink control channel (e.g., PUCCH) configuration (e.g., format, time/frequency resources, etc.), etc. The configuration may be communicated to the WTRU, e.g., using higher layer (e.g., RRC) signaling, etc. Alternatively, the WTRU may use a higher layer signaling, (e.g., sending a RRC message), containing the report. Alternatively, the WTRU may be configured to send the report as an uplink MAC-CE message. Alternatively, the WTRU may send the report using the uplink data channel (e.g., PUSCH). For the uplink data channel, the WTRU may be configured with the time-frequency resources. If the WTRU does not have allocated resources, the WTRU may request to the network (e.g., serving gNB) to allocate the time-frequency resources (e.g., by sending a scheduling request).

The reporting configuration containing one or more of the parameters including the value of N, time-to-trigger, reporting format (e.g., how many bits needs to be used, absolute vs relative beam indication), beam indexing pattern (e.g., in case of absolute beam index reporting) may be communicated to the WTRU (e.g., in RRC configuration or system information).

In an embodiment, the reporting configuration may be antenna panel specific. In case of multiple antenna panels supported at the WTRU, the WTRU may be configured with reporting configuration for each panel. In an embodiment, the WTRU may be configured to send an uplink indication (e.g., using uplink control information, RRC signaling, or an uplink MAC-CE message) when there is any change in the antenna panel used/selected by the WTRU to communicate with the network (e.g., serving/source gNB). In an embodiment, the uplink indication may contain the information of antenna panel, e.g., antenna panel identification, if the other information, e.g., angular coverage of each panel, maximum/minimum WTRU Tx/Rx beam-width (e.g., 3 dB or half power beam width) has already sent by the WTRU to the network (e.g., serving gNB) for example, as part of the WTRU capability. In an embodiment, the WTRU may send antenna panel identification, angular coverage of any (e.g., each) antenna panel, or/and maximum/minimum WTRU Tx/Rx beam-width (e.g., 3 dB or half power beam width) to the serving gNB, when there is any change in the antenna panel used/selected by the WTRU to communicate with the serving gNB. After sending this indication, the WTRU may receive a reporting configuration (e.g., containing one or more of the parameters including the value of N, time-to-trigger, reporting format), for example, when the WTRU was not already configured with reporting configuration for the reported antenna panel.

In an embodiment, the WTRU may be configured (e.g., by the network) to send periodic WTRU reports indicating the WTRU Tx/Rx beam being used/selected by the WE to communicate with the network. For an antenna panel, a beam indexing format/pattern may be used, for example the beam indexing may start from left most beam of FoV of the antenna panel as shown in FIG. 8. The WTRU may be configured (e.g., by the network) for the beam indexing method/format. The WTRU may be configured to send ceil (log 2 (maximum number of beams which can be formed to cover the FoV of the antenna panel)) bits in the WTRU report. For example, as shown, referring to FIG. 8, the following indications may be used by the WTRU: 0000 for beam 1, 0001 for beam 2, 0010 for beam 3, 0011 for beam 4, 0100 for beam 5, 0101 for beam 6, 0110 for beam 7, 0111 for beam 8, 1000 for beam 9.

The WTRU may be configured with periodic reporting configuration by the network (e.g., serving gNB) via, for example, higher layer signaling (e.g., RRC signaling). The reporting configuration may contain one or of the parameters including periodicity, offset, etc. The WTRU may send the report using uplink control channel as part of the uplink control information. The configuration of uplink control channel resources (e.g., uplink channel format, time-frequency resources, etc.) may be configured to the WTRU, for example, as part of the reporting configuration.

In an embodiment, the WTRU may be configured to send WTRU reports indicating the WTRU Tx/Rx beam being used/selected by the WTRU to communicate with the network in a semi-persistent manner. The WTRU may be pre-configured with one or more reporting configurations. At least one (e.g., each) of the reporting configurations containing one or more of the parameters including periodicity, offset, uplink control channel parameters (e.g., format, time-frequency resources, etc.), reporting configuration ID, etc., using the higher layer signaling (e.g., RRC signaling). The WTRU may activate the reporting, for example, when the WTRU receives a downlink MAC-CE or downlink control information containing the reporting configuration ID which needs to be used by the WTRU. In an embodiment, the WTRU may be pre-configured with one or more reporting configurations, at least one (e.g., each) of the reporting configurations containing one or more of the parameters including periodicity, offset, reporting configuration ID, etc., using the higher layer signaling (e.g., RRC signaling). The WTRU may activate the reporting, for example, when the WTRU receives a downlink control information (e.g., DCI 01) containing the reporting configuration ID which needs to be used by the WTRU. The downlink control information (DCI) may be scrambled with WTRU's radio network temporary identifier (RNTI) ((e.g., C-RNTI) or a new RNTI may be used for this purpose, for example, semi persistent WTRU beam information RNTI (SP-UBI-RNTI), which may be used by the WTRU to de-scramble the DCI. The DCI may contain the time-frequency resource allocation information to be used by the WTRU to send the reports. In an embodiment, the WTRU may be stop sending the periodic reports when the WTRU receives a command to deactivate/terminate the reporting from the network. For example, this command to deactivate/terminate the reporting may be received in downlink MAC-CE or DCI.

In an embodiment, the WTRU may be configured to send WTRU reports indicating the WTRU Tx/Rx beam being used/selected by the WTRU to communicate with the network in an aperiodic manner. The WTRU may send the report, for example, when the WTRU receives a downlink control information (e.g., DCI 01) indicating the need of WTRU report. The DCI may be scrambled with WTRU's RNTI (e.g., C-RNTI) or a new RNTI may be used for this purpose, for example, aperiodic WTRU beam information RNTI (A-UBI-RNTI), which may be used by the WTRU to de-scramble the DCI. The DCI may contain the time-frequency resource allocation information to be used by the WTRU to send the report.

In an embodiment, the reporting configuration may be antenna panel specific. In case of multiple antenna panels supported at the WTRU, the WTRU may be configured with reporting configuration for at least one (e.g., each) antenna panel. In an embodiment, the WTRU may be configured to send an uplink indication (e.g., using uplink control information, RRC signaling, or an uplink MAC-CE message) when there is any change in the antenna panel used/selected by the WTRU to communicate with the network (e.g., serving gNB). In an embodiment, the uplink indication may contain the information of antenna panel (e.g., antenna panel identification), if the other information, e.g., angular coverage of any (e.g., each) antenna panel maximum/minimum WTRU Tx/Rx beam-width (e.g., 3 dB or half power beam width), has already sent by the WTRU to the network (e.g., serving gNB) for example, as part of the WTRU capability. In an embodiment, the WTRU may send antenna panel identification, angular coverage of any (e.g., each) antenna panel, or/and maximum/minimum WTRU Tx/Rx beam-width (e.g., 3 dB or half power beam width) to the serving gNB, when there is any change in the antenna panel used/selected by the WTRU to communicate with the serving gNB. After sending this indication, the WTRU may receive a new/reconfigured reporting configuration, e.g., for periodic or semi-persistent reporting, for example, when the WTRU was not already configured with reporting configuration for the reported antenna panel.

For all different types of reporting mechanisms, the reporting may be configured to depend upon the priority of the traffic that WTRU is exchanging with the network. This may be important as in some cases a WTRU may be exchanging traffic of different priorities. The priority may be the logical channel priority from the MAC layer, or it may be the priority indication available at higher layers and communicated to lower layers to be used in the orientation reporting framework.

In various embodiments, indicating WTRU orientation may be provided based on uplink SRSs. This may be used when SRSs are used for uplink beam management, for example, when the beam correspondence is not supported at the WTRU. In an embodiment, for at least one (e.g., each) antenna panel, the WTRU may be configured to assign different SRS, e.g., SRS ID, for each WTRU Tx beam. The association between the physical beams and the SRS IDs may be configured to the WTRU. For example, referring to FIG. 8, the beam 1 may be configured to use the lowest SRS ID, e.g., SRS ID of 1, then beam 2 may be configured to use SRS ID of 2, and so on. Based on the SRS selected (e.g., based on the uplink beam management procedure) for the communication by the gNB and the other information, the network may determine the WTRU orientation (e.g., which WTRU Tx beam is being used/selected by the WTRU). The other information may be any of the total number of beams supported by the WTRU (e.g., for the WTRU antenna panel being used for the communication) which may be part of the WTRU capability information or may be derived from the maximum angular coverage, the beam-width information given in the WTRU capability information, and the association between the physical beam and the SRS IDs, The association between the physical beams and the SRS IDs for any (e.g., each) antenna panel may be configured to the WTRU by the network via higher layer signaling (e.g., RRC signaling), or system information.

In an embodiment, if the WTRU is configured with event, periodic, semi-persistent, or aperiodic reporting to indicate the WTRU Tx beam being used/selected for the communication with the serving gNB, the WTRU may use the SRS ID associated with the beam.

Based on the explicit or implicit indication of WTRU Tx or Rx beam, the serving gNB (e.g., source gNB) may determine the one or more candidate/potential cells/gNBs for the WTRU's CHO. For example, referring to FIG. 8, if the WTRU uses beam 1 to communicate with the serving gNB (e.g., gNB1), the gNB1 may configure gNB2, otherwise, if the WTRU uses beam 9 to communicate with gNB1, the gNB1 may configure gNB3 for the CHO. The serving gNB may communicate with the selected candidate gNBs to configure CHO. The serving gNB may receive acknowledgement and the CHO configuration (e.g., containing PCI-ID, SSB to RACH resource mapping, CFRA related parameters, etc.) from the candidate gNBs.

The serving gNB may send a RRC Reconfiguration message containing CHO configuration of candidate gNBs and the CHO execution conditions to the WTRU. The CHO execution condition may contain the reference signals information (e.g., reference signals to be measured, time-frequency resources, etc.). The thresholds need to be applied to derive the handover conditions based on the measurements (e.g., A3/A5 events-based measurements). After a rotation, if one of the configured candidates gNB comes into the FoV of the WTRU's antenna panel and if the CHO execution condition is satisfied based on the WTRU measurements, the WTRU may detach from the serving/source gNB, and the WTRU may apply the given configuration for the selected candidate gNB to synchronize and to handover to the selected gNB.

Referring to FIG. 9, in an embodiment, a method performed by a WTRU to support CHO procedure may comprise any of the following actions:

At step 1, the WTRU may send to the the serving gNB (e.g., gNB1) WTRU capability information containing any of the number of antenna panels, (e.g., maximum) angular coverage of any (e.g., each) antenna panel, maximum/minimum WTRU Tx/Rx beam-width (e.g., 3 dB or half power beam width), location of the antenna panels on the WTRU, etc.

At step 2, the WTRU may receive, from the serving gNB, reporting configuration for event based reporting containing any of the value of N edge beams, time-to-trigger, reporting format (e.g., how many bits need to be used, absolute vs relative beam indication), uplink resource configuration, etc.

At step 3, on a condition that the WTRU uses one of the N edge beams of the antenna panel (currently being used to communicate with the serving gNB) for duration of time-to-trigger, the WTRU may send to the the serving gNB, a report to the serving/source gNB containing the bit information associated with the beam using a MAC-CE message.

At step 4, the WTRU may receive, RRC Reconfiguration message from the serving gNB (e.g., gNB1) containing the CHO configuration for one or more candidate gNBs (e.g., gNB2) and the CHO execution condition.

At step 5, the WTRU may start evaluating the CHO execution conditions for the candidate gNBs (e.g., gNB2). If at least one candidate gNB satisfies the corresponding CHO execution condition, the WTRU may detach from the source gNB (e.g., gNB1), applies the stored corresponding configuration for the selected candidate cell (e.g., gNB2), synchronizes to that candidate gNB and completes the RRC handover procedure by sending

RRCReconfigurationComplete message to the target gNB (e.g., gNB2).

In addition to the above steps illustrated on FIG. 9, the method may comprise any of the following actions:

on a condition that: the WTRU uses one of the N edge beams of the antenna panel, and the channel quality measurement resource associated to the DL transmission (DMRS, CSI-RS or SSB) falls within a range, where the range is configured to the WTRU, the WTRU may send a report to the source gNB (e.g., gNB1) containing the bit information associated with the beam using a MAC-CE message;

the WTRU may be configured to send the report using uplink control information;

the WTRU may use a higher layer signaling, e.g., sending a RRC message, to send the report;

report may contain one bit information to indicate that the one of the N edge beams is being selected/used;

report may contain ‘ceil (log2(N))+1’ where the most significant bit may be used to indicate the edge of FoV and the remaining bits may be used to indicate the beam;

report may contain the absolute WTRU beam ID where A beam indexing format/pattern may be communicated;

the WTRU may be configured with periodic reporting configuration to send the selected WTRU Tx/Rx beam using RRC signaling;

the WTRU may be configured to send reports in semi-persistent manner to report the selected WTRU Tx/Rx beam using RRC and MAC-CE or DCI signaling;

the WTRU may be configured to send reports in aperiodic manner to report the selected WTRU Tx/Rx beam using DCI signaling;

the WTRU may be configured with reporting configuration for each antenna panel;

the WTRU may be configured to send an indication when there is any change in the antenna panel used/selected by the WTRU to communicate with the network. After sending the antenna panel change indication, the WTRU may receive new reporting configuration for the new antenna panel.

In another embodiment, a method performed by a WTRU to support CHO procedure may comprise any of the following actions:

The WTRU may send WTRU capability information containing the number of antenna panels, (e.g., maximum) angular coverage of any (e.g., each) antenna panel, maximum/minimum WTRU Tx/Rx beam-width (e.g., 3 dB or half power beam width), or/and location of the antenna panels on the device, etc.

The WTRU may receive an association mechanism between the physical beams and the SRS IDs for each antenna panel.

The WTRU may receive RRC reconfiguration message from the serving gNB containing the CHO configuration for one or more candidate gNBs and the CHO execution condition.

The WTRU may start evaluating the CHO execution conditions for the candidate gNBs. If at least one CHO candidate gNB satisfies the corresponding CHO execution condition, the WTRU may detach from the source gNB, applies the stored corresponding configuration for that selected candidate cell, synchronizes to that candidate gNB and completes the RRC handover procedure by sending RRCReconfigurationComplete message to the target gNB.

In addition to the above actions, the method may further comprise any of the following action:
the WTRU may be configured to send SRS-ID of the WTRU beam being used to communicate to the serving/source gNB;
the WTRU may be configured to send SRS-ID of the WTRU beam being used to communicate to the serving/source gNB as event based reporting where event may be defined as when the WTRU selects/uses one of the N edge beams;
the WTRU may be configured to send the report using MAC-CE or uplink control information or RRC signaling;
the WTRU may be configured with periodic reporting configuration to send the SRS-ID of the selected WTRU Tx/Rx beam using RRC signaling;
the WTRU may be configured to send reports in semi-persistent manner to report the SRS-ID of the selected WTRU Tx/Rx beam using RRC and MAC-CE or DCI signaling;
the WTRU may be configured to send reports in aperiodic manner to report the SRS-ID of the selected WTRU Tx/Rx beam using DCI signaling;
the WTRU may be configured to send an indication when there is any change in the antenna panel used/selected by the WTRU to communicate with the network. After sending the antenna panel change indication, the WTRU may receive new reporting configuration for the new antenna panel.

The following embodiments are related to the scenarios, when the WTRU rotates, and the angular coverage or FoV of the WTRU's antenna panel(s) may have new gNB/gNBs which were not in the FoV of the WTRU's antenna panel(s) before the WTRU's rotation.

The WTRU may not be configured by the source gNB with handover configuration for the gNB/gNBs available in the WTRU's updated FOV after the rotation because of the lack of the WTRU measurement reports associated with those gNBs. Therefore, after a sudden WTRU rotation (e.g., or a blockage), the source gNB may not be able to initiate a handover procedure in time based on the most recent measurement reports. Without handover assistance from the source gNB, even when there are potential target gNBs with good channel qualities (e.g., above a threshold), the WTRU may need either to wait for the source gNB to recover from outage or declare an RLF. In such scenarios, since the channel quality with the source gNB may deteriorate (e.g., below a threshold) because of the WTRU rotation movement and since there is no other gNB (e.g., with good channel quality, e.g., channel quality above a threshold) configured for handover, the WTRU may perform beam failure detection procedure to declare the poor channel quality (e.g., below a threshold) with the source gNB with the current gNB beam and may perform beam failure recovery procedure to determine another suitable gNB beam. If the channel quality does not recover (e.g., become above a threshold) during the beam failure detection and the recovery procedure, the WTRU may declare an RLF. In fact, both the beam failure/recovery and radio link procedure will start to execute at the WTRU as per the configuration parameters and WTRU may declare the events to higher layers accordingly.

When the source gNB is out of the FoV of the WTRU's antenna panel(s), the channel quality may become poor (e.g., below a threshold). This may continue to be poor until the source gNB comes again in FoV of the WTRU's antenna panel(s). Therefore, long beam failure detection and recovery procedure to declare RLF when the source gNB is out of the FoV of the WTRU's antenna panel(s) may unnecessarily increase the outage duration.

In an embodiment, the parameters of the beam failure detection and recovery procedure based on the WTRU's orientation are dynamically adapted. A WTRU may be configured to send information to the network (e.g., serving/source gNB) about its capability (e.g., WTRU capability) containing one or more of the parameters including number of antenna panels, (e.g., maximum) angular coverage of any (e.g., each) antenna panel, maximum/minimum WTRU Tx/Rx beam-width (e.g., 3 dB or half power beam width), location of the antenna panels on the WTRU, etc. The total number of beams which may be formed within the antenna panel's FOV may be provided in the WTRU capability information or this may be derived using the beam-width and the angular coverage information. Angular coverage information in both azimuth and elevation dimension may be provided to the network. The location of (e.g., other) antenna panels (e.g., 2D or 3D coordinates) may be provided relative to the antenna panel being used/selected to communicate with the network (e.g., serving gNB). Alternatively, absolute location relative to the device center in terms of 2D or 3D coordinates or in terms of named direction such as north, south-east, etc. may be provided. The WTRU capability information may be sent using higher layer signaling, e.g., RRC uplink message. In another example, the WTRU capability information may be sent as uplink control information over the control channel (e.g., PUCCH).

The WTRU may receive beam failure detection configuration from the network (e.g., serving/source gNB). The beam failure detection configuration may contain one or more parameters. The WTRU may be configured with multiple beam failure detection configurations, each containing one or more parameters with different value compared to other configurations, may have an identification, e.g., beam failure detection configuration ID (or Radio Link Monitoring Config 1D if the beam failure configuration is contained within the Radio Link Monitoring Config). In an embodiment, the WTRU may also receive association/mapping between the beam failure detection configuration and each or a set of WTRU beams (e.g., WTRU Tx/Rx beam).

max count (e.g.,

In an embodiment, the value of the beam failure beamFailureInstanceMaxCount), e.g., maximum number of beam failure instances used to trigger beam failure receiver, may be associated with the selected WTRU's Tx/Rx beam.

Different/separate values for the beam failure max count may be configured for each or a set of WTRU beams. For example, referring to FIG. 8, the edge beams (e.g., beam 1, beam 2, beam 8, beam 9) may be configured with lower value of beam failure max count (e.g., beamFailureInstanceMaxCount=2) compared to the value assigned for central beams (e.g., beam 5 and beam 6), e.g., beamFailureInstanceMaxCount=8. This is because when the WTRU uses/selects one of the edge beams to communicate with the serving/source gNB and if the WTRU rotates and the channel quality deteriorates, the source gNB may probably be out of the FoV; therefore, with lower value of beam failure max count, beam failure detection may be faster. Beams may be grouped and may be assigned same value of the beam failure max count. Alternatively, each beam may be assigned with a different/separate value of the beam failure max count. The WTRU may use the associated value of the beam failure max count based on the selected WTRU Tx/Rx beam prior to losing connection with the serving gNB. This loss of connection may be the result of WTRU rotation or some other external environmental factors. If the WTRU switches the WTRU Tx/Rx beam, the WTRU may use the beam failure max count associated with the new WTRU Tx/Rx when the WTRU performs beam failure detection procedure.

In an embodiment, the value of the beam failure detection timer (e.g., beamFailureDetectionTimer) may be associated with the selected WTRU's Tx/Rx beam. Different/separate values for the beam failure detection timer may be configured for each or a set of WTRU beams. For example, referring to FIG. 8, the edge beams (e.g., beam 1, beam 2, beam 8, beam 9) may be configured with lower (or Higher) value of beam failure detection time (e.g., beamFailureDetection Timer=1) compared to the value assigned for central beams (e.g., beam 5 and beam 6), e.g., beamFailureDetectionTimer=10. Assigning/determining the lower values to edge beams may enable the WTRU to complete beam failure detection procedure faster when the serving/source gNB becomes out of the FoV of the WTRU's antenna panel(s), e.g., due to WTRU rotations, and which may help to declare RLF sooner. Beams may be grouped and may be assigned same value of the beam failure detection time. Alternatively, each beam may be assigned/determined with a different/separate value of the beam failure detection time. The WTRU may use the associated value of the beam failure detection time based on the selected WTRU Tx/Rx beam. If the WTRU switches the WTRU Tx/Rx beam, the WTRU may use the beam failure detection time associated with the new WTRU Tx/Rx when the WTRU performs beam failure detection procedure.

The beam failure detection configuration with one or more parameters associated with the WTRU's Tx/Rx beam may be given to the WTRU by the network (e.g., serving/source gNB) via higher layer signaling, e.g., RRC signaling, system information, MAC-CE, or DCI.

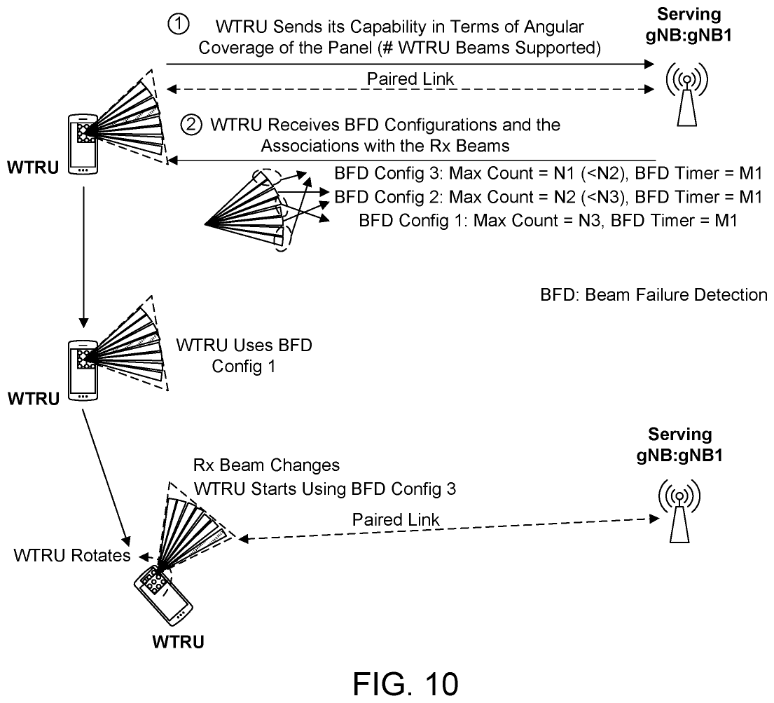

Referring to FIG. 10, an embodiment of WTRU Tx/Rx beam based beam failure detection procedure is shown, where different values of beam failure max count and the beam failure detection timer are given for the central and edge WTRU beams. Based on the selected WTRU beam, the WTRU may determine the appropriate configuration to use for beam failure detection procedure.

In an embodiment, the value of the out of sync threshold (e.g., Q_out_LR) which is used as quality threshold to determine a beam failure instance may be associated with the WTRU's selected Tx/Rx beam. As a non-limited example, a beam failure instance may be declared when the quality (e.g., RSSI/RSRP) of the downlink control channel used to monitor the beam quality is below the out of synch threshold. One or more values of out of sync threshold may be configured for one or more WTRU's Tx/Rx beams. For example, edge beams (e.g., beam 1, beam 2, beam 8, beam 9 in FIG. 8) may be assigned higher values of out of sync threshold compared to the values assigned to central beams (e.g., beam 5 and beam 6 in FIG. 8). This is to enable the WTRU to complete beam failure detection procedure faster when the serving/source gNB becomes out of the FoV of the WTRU's antenna panel(s), e.g., due to WTRU rotations, and which may help to declare RLF sooner. The values of the out of sync threshold and its association for the WTRU Tx/Rx beams may be configured to the WTRU by the network (e.g., serving/source gNB) via for example, higher layer signaling (e.g., RRC signaling), MAC-CE, DCI, or system information.

In an embodiment, the WTRU may be configured with multiple radio link failure detection configurations, each containing one or more parameters (e.g., timer T310, timer 312, constant N310, etc.) with different value compared to other configurations. The WTRU may have an identification, e.g., radio failure detection configuration ID (or Radio Link Monitoring Config 1D if the radio link failure configuration is contained within the Radio Link Monitoring Config). In an embodiment, the WTRU may also receive association/mapping between the radio link failure detection configuration and each or a set of WTRU beams (e.g., WTRU Tx/Rx beam).

In an embodiment, the value of the counter N310, e.g., maximum number of consecutive instances for which the link is declared out-of-sync (e.g., link quality is below a threshold), may be associated with the selected WTRU's Tx/Rx beam. In an embodiment, the value of the timer T310, which is triggered after receiving N310 consecutive out-of-synch indication for the link with the source gNB, and after its expiry the radio link failure is declared by the WTRU, may be associated with the selected WTRU's Tx/Rx beam. In an embodiment, the value of the timer T312 may be associated with the selected WTRU's Tx/Rx beam. For example, referring to FIG. 8, the edge beams (e.g., beam 1, beam 2, beam 8, beam 9) may be configured with lower value of N310, T310, or/and T312 compared to the value assigned for central beams (e.g., beam 5 and beam 6). This is because when the WTRU uses/selects one of the edge beams to communicate with the serving/source gNB and if the WTRU rotates and the channel quality deteriorates, the source gNB may probably be out of the FoV; therefore, with lower value of N310, T310, or/and T312, radio link failure detection may be faster.

In an embodiment, when the WTRU is configured with multiple beam or/and radio link failure detection configurations, and on a condition that the WTRU switches its Tx/Rx beam and determines to switch the beam or radio link failure detection configuration (e.g., start using the different configuration from the previous one), where difference in the configuration with respect to the previous one may be for example in one of beam failure max count, beam failure timer, out of sync threshold, etc., the WTRU may send an indication to the network, e.g., serving/source gNB. The indication may contain the ID of the beam or radio link failure detection configuration the WTRU determines to switch. In an embodiment, the indication may contain the parameter (e.g., beam failure max count, beam failure detection timer, out of synch threshold, N310 constant, T310 timer, T312 timer etc.) and its value (e.g., new value) which the WTRU determines to switch. The WTRU may be configured to send the indication to the network via, MAC-CE, or RRC signaling or as uplink control information.

In an embodiment, the WTRU may be pre-configured with multiple beam or/and radio link failure detection configurations (e.g., each configuration may be identified with an ID, and may have different values of one or more parameters in association with one or more WTRU's Tx/Rx beams compared to other configurations) and only one configuration may be activated initially. The pre-configuration and the activated configuration may be given to the WTRU by the network, via for example, higher layer signaling, e.g., RRC signaling or system information. The WTRU may be configured with event based reporting for its selection of one of the edge beams. In an embodiment, the WTRU may be configured to send periodic, semi-persistent or aperiodic reports containing the WTRU Tx/Rx beam information to the WTRU. The network (e.g., serving/source gNB) may determine to configure different beam or/and radio link failure detection configuration based on the WTRU's Tx/Rx beam selection. After sending such report, the WTRU may receive an activation command, e.g., using RRC signaling, MAC-CE command, or a DCI, containing the beam or/and radio link failure detection configuration ID to be activated. After receiving an activation command, the WTRU may deactivate the previous configuration and may start using the latest received beam or/and radio link failure detection configuration.

In an embodiment, the WTRU may be configured with one beam or/and radio link failure detection configuration initially via for example, higher layer signaling (e.g., RRC signaling) or system information. The WTRU may be configured with event based reporting for its selection of one of the edge beams. In an embodiment, the WTRU may be configured to send periodic, semi-persistent or aperiodic reports containing the WTRU Tx/Rx beam information to the WTRU. The network (e.g., serving/source gNB) may determine to configure different beam failure detection configuration based on the WTRU's Tx/Rx beam selection. After sending such report, the WTRU may receive another (e.g., new) beam or/and radio link failure detection configuration from the network, e.g., using RRC signaling, MAC-CE command, or a DCI, containing the values of the parameters, e.g., beam failure maximum count, beam failure detection timer, N310 constant, T310 timer, T312 timer, etc. After receiving the new beam or/and radio link failure detection configuration, the WTRU may start using that configuration.

In an embodiment, when SRSs are used for uplink beam management, for example, when the beam correspondence is not supported at the WTRU, the WTRU may be configured to assign different SRS, e.g., SRS ID, for each WTRU Tx beam and the association between the physical beams and the SRS IDs may be configured to the WTRU.

Based on the SRS selected (e.g., based on the uplink beam management procedure) for the communication by the gNB and other information, the network may determine the WTRU orientation (e.g., which WTRU Tx beam is being used/selected by the WTRU). The other information may include total number of beams supported by the WTRU (e.g., for the WTRU antenna panel being used for the communication) which may be part of the WTRU capability information or may be derived from the maximum angular coverage and the beam-width information given in the WTRU capability information. In addition, the WTRU orientation may be determined based on the SRS selected for the communication by the gNB, the other information, and on the association between the physical beam and the SRS IDs.

The association between the physical beams and the SRS IDs for any (e.g., each) antenna panel may be configured to the WTRU by the network via higher layer signaling, e.g., RRC signaling, or system information. In an embodiment, the WTRU may be configured with event based reporting for its selection of one of the edge beams where the WTRU may use SRS-IDs of the associated reporting beam. Based on the network (e.g., serving/source gNB) determination of the WTRU orientation using the selected SRS ID or WTRU reports, the network (e.g., serving/source gNB) may dynamically configure the WTRU with the appropriate beam failure detection configuration based on the WTRU beam associated with the SRS ID. The beam or/and radio link failure detection configuration may be sent to the WTRU dynamically using for example, MAC-CE, DCI, or RRC signaling. After receiving the new beam or/and radio link failure detection configuration, the WTRU may start using that configuration.

In an embodiment, beam or/and radio link failure detection configuration may be antenna panel specific. In case of multiple antenna panels supported at the WTRU, the WTRU may be configured with beam or/and radio link failure detection configuration for any (e.g., each) antenna panel. In one example, the WTRU may be configured to send an uplink indication (e.g., using uplink control information, RRC signaling, or an uplink MAC-CE message) when there is any change in the antenna panel used/selected by the WTRU to communicate with the network (e.g., serving gNB). In an embodiment, the uplink indication may contain the information of antenna panel (e.g., antenna panel identification) if the other information, e.g., angular coverage of any (e.g., each) antenna panel, maximum/minimum WTRU Tx/Rx beam-width (e.g., 3 dB or half power beam width) may have been already sent by the WTRU to the network (e.g., serving gNB) for example, as part of the WTRU capability. In another example, the WTRU may send antenna panel identification, angular coverage of any (e.g., each) antenna panel, or/and maximum/minimum WTRU Tx/Rx beam-width (e.g., 3 dB or half power beam width) to the serving gNB, when there is any change in the antenna panel used/selected by the WTRU to communicate with the serving gNB. After sending this indication, the WTRU may receive a new/reconfigured beam or/and radio link failure detection configuration, e.g., containing multiple configurations associated with different WTRU Tx/Rx beams, for example, when the WTRU was not already configured with beam or/and radio link failure detection configuration for the reported antenna panel.

In an embodiment, a method performed by a WTRU to support beam failure detection procedure may comprise at least one of the following actions:

The WTRU may send, to the network, WTRU capability information containing the number of antenna panels, (e.g., maximum) angular coverage of any (e.g., each) antenna panel, maximum/minimum WTRU Tx/Rx beam-width (e.g., 3 dB or half power beam width), or/and location of the antenna panels on the WTRU, etc.

The WTRU may receive, from the network, one or more beam failure detection configurations, at least one (e.g., each) of the beam failure detection configurations containing ID, different/separate values of one of more parameters associated with one or more WTRU's Tx/Rx beams.

On a condition when the WTRU's beam is changed with the same antenna panel and the same serving/source gNB, the WTRU may determine the beam failure detection configuration to be used based on the selected WTRU beam and the given configurations.

The WTRU may send, to the network, the WTRU indication containing the beam failure detection configuration ID if the beam failure configuration is different from the previously selected configuration.

Referring to the above method:

the indication may contain the parameter (e.g., beam failure max count, beam failure detection timer, out of synch threshold, etc.) and its value (e.g., new value) which the WTRU may determine to switch.

the WTRU may receive association between the beam failure detection configuration and the WTRU beam: in the beam failure detection configuration, the value of the beam failure detection max count may be associated with the WTRU beam or a group of WTRU beams; in the beam failure detection configuration, the value of the beam failure detection timer may be associated with the WTRU beam or a group of WTRU beams; in the beam failure detection configuration, the value of the out of sync threshold may be associated with the WTRU beam or a group of WTRU beams.

the WTRU may be configured with multiple beam failure detection configurations with one configuration activated initially: the WTRU may be configured to report (event based when WTRU starts using one of the N edge beams, periodic, semi-persistent or aperiodic) about its selected Tx/Rx beam; the WTRU may be configured to activate a beam failure detection configuration based on its reporting of the WTRU Tx/Rx beam.

the WTRU may be configured with an association mechanism between the physical beams and the SRS IDs for each antenna panel: the WTRU may use SRS IDs to report the WTRU beams (if configured); the WTRU may receive beam failure detection configuration when there is any change in the WTRU beam and the network determines to change the configuration based on its detection of WTRU beam change using the SRS IDs.

the WTRU may be configured with beam failure detection configurations for any (e.g., each) antenna panel.

the WTRU may be configured to send an indication when there is any change in the antenna panel used/selected by the WTRU to communicate with the network: after sending the antenna panel change indication, the WTRU may receive new beam failure detection configuration (with its association with the WTRU beams) for the new antenna panel.

In an embodiment, a method performed by a WTRU to support link failure detection procedure may comprise at least one of the following actions:
The WTRU may send, to the network, capability information containing the number of antenna panels, (e.g., maximum) angular coverage of any (e.g., each) antenna panel, maximum/minimum WTRU Tx/Rx beam-width (e.g., 3 dB or half power beam width), or/and location of the antenna panels on the device, etc.

The WTRU may receive, from the network, one or more radio link failure detection configurations, at least one (e.g., each) of the radio link failure detection configurations containing ID, different/separate values of one of more parameters associated with one or more WTRU's Tx/Rx beams.

On a condition when the WTRU's beam is changed with the same antenna panel and the same serving/source gNB, the WTRU may determine the radio link failure detection configuration to be used based on the selected WTRU beam and the given configurations.

The WTRU may send, to the network, indication containing the beam failure detection configuration ID if the radio link failure configuration is different from the previously selected configuration.

Referring to the above method:
the indication may contain the parameter (e.g., N310 constant, T310 timer, T312 timer, etc.) and its value (e.g., new value) which the WTRU may determine to switch;
the WTRU may receive association between the radio link failure detection configuration and the WTRU beam: in the radio link failure detection configuration, the value of the N310, T310, or/and T213 may be associated with the WTRU beam or a group of WTRU beams.

the WTRU may be configured with multiple radio link failure detection configurations with one configuration activated initially: the WTRU may be configured to report (event based when WTRU starts using one of the N edge beams, periodic, semi-persistent or aperiodic) about its selected Tx/Rx beam; the WTRU may be configured to activate a radio link failure detection configuration based on its reporting of the WTRU Tx/Rx beam.

the WTRU may be configured with an association mechanism between the physical beams and the SRS IDs for each antenna panel: the WTRU may use SRS IDs to report the WTRU beams (if configured); the WTRU may receive radio link failure detection configuration when there is any change in the WTRU beam and the network determines to change the configuration based on its detection of WTRU beam change using the SRS IDs.

the WTRU may be configured with radio link failure detection configurations for each antenna panel.

the WTRU may be configured to send an indication when there is any change in the antenna panel used/selected by the WTRU to communicate with the network: after sending the antenna panel change indication, the WTRU may receive new radio link failure detection configuration (with its association with the WTRU beams) for the new antenna panel.

In various embodiments, beam failure detection procedure may be optimized using locally available information at a WTRU device about its movement.

In an embodiment, the WTRU may be equipped with a gyroscope. A lot of smart phones and wearable devices are currently equipped with such gyroscopes. These gyroscopes may provide a WTRU the indication of amount of rotation that it made along with the direction in terms of clockwise or counter-clockwise rotation. Prior to rotation event, if this WTRU was connected to its serving/source gNB through one of its edge beams, having received the rotation amount and direction from the gyroscope, a WTRU may determine whether this rotation will change the WTRU FoV out of its serving gNB coverage. Having determined being out of coverage from its last serving gNB, a WTRU may short-circuit beam failure detection procedure. The configuration parameters to be employed when a WTRU determines being out of coverage may be configured through static or dynamic configurations presented earlier in this embodiment. In one extreme case, WTRUs may be configured with zero wait beam failure detection, (e.g., upon determining being out of coverage, a WTRU may declare BFD with zero delay).

In an embodiment, the WTRU may declare radio link failure with zero delay after having determined that the WTRU is out of coverage from its source gNB.

The rotation information may not necessarily be locally available at the WTRU. There may be different mechanisms through which a WTRU may be receiving the information regarding its rotation. This may come from a different radio interface that a WTRU may be equipped with, and it may be computed through some other positioning/localization signals which might be available. Similarly, the availability of measurements made locally or externally for angle of departure, angle of arrival etc., may be used to determine the amount of rotation a WTRU makes, and then may be applied to speed up beam failure or link failure procedures, which in turn let the WTRU find suitable neighboring beams/gNBs faster and reduce the outage time.

The faster beam or radio link failure detection or short-circuiting of beam failure detection (BFD) procedure may not be limited to WTRU using one of its edge beams. Even if a WTRU is connected to its serving/source gNB through one of its middle beams, a large rotation event may result this WTRU going out of coverage of its serving gNB. To cover such practical situations, after rotation events, a WTRU may be configured to evaluate whether the current rotation may lead to being out of coverage or not. This evaluation may use the information of the WTRU FoV parameters, last serving beam prior to rotation event and the rotation information. This may enable a WTRU to determine its status in terms of in-coverage or out-of-coverage with minimal delay. This is actually even faster than the time it may be required to make a single measurement on SSB or CSI-RS. For some WTRUs/devices having a large number of rotation events or constraints in terms of computational complexity resulting from energy consumption or availability of hardware, it may not be possible to evaluate in-coverage/out-of-coverage status after each rotation. This can be simplified by conditioning such evaluations if WTRU was connected to the serving gNB through one of its N edge beams (N being a configuration parameter), or if the amount of rotation exceeds (e.g., goes beyond) a configured rotational threshold, or a combination thereof.

In an embodiment, a method performed by a WTRU to support beam failure detection procedure may comprise at least one of the following actions:
The WTRU may send, to the network, WTRU capability information containing the number of antenna panels, (e.g., maximum) angular coverage of any (e.g., each) antenna panel, maximum/minimum WTRU Tx/Rx beam-width (e.g., 3 dB or half power beam width), or/and location of the antenna panels on the WTRU, etc.

The WTRU may receive, from the network, beam failure detection configuration along with an indication/flag if the WTRU is allowed to expedite the beam failure detection procedure based on the rotation information available at the WTRU side.

On a condition when the source gNB/active beam undergoes quality degradation, the WTRU may evaluate/determine its current coverage status with the prior coverage status with its active beam and the amount of rotation it underwent. If the rotation leads the WTRU out of the prior FoV, the WTRU may use the specific configuration parameters configured for the beam failure detection with the source gNB for the case when it estimates being out of FoV and subsequently initiates the beam failure recovery procedure.

Referring to the above method:

the WTRU may have received the configuration parameters or indication such that when it determines being out of prior FoV, it declares beam failure with zero delay and starts beam recovery procedure.

the WTRU, after a rotation event and upon determining out of prior FoV, may start radio link failure procedure with configured expedited parameters.

the WTRU may receive, from the network, an indication/flag if the WTRU is allowed to declare the radio link failure detection based on the rotation information available at the WTRU side: on a condition when the source gNB is out of the field of view based on the rotation information available at the WTRU, the WTRU may declare the radio link failure detection with the source gNB.

A WTRU may be configured to send information to the network (e.g., serving gNB) about its capability (e.g., WTRU capability) containing one or more of the parameters including number of antenna panels, (e.g., maximum) angular coverage of any (e.g., each) antenna panel, maximum/minimum WTRU Tx/Rx beam-width (e.g., 3 dB or half power beam width), location of the antenna panels on the WTRU, etc. The total number of beams which may be formed within the antenna panel's FoV may be provided in the WTRU capability information or this may be derived using the beam-width and the angular coverage information. Angular coverage information in both azimuth and elevation dimension may be provided to the network. The location of (e.g., other) antenna panels (e.g., 2D or 3D coordinates) may be provided relative to the antenna panel being used/selected to communicate with the network, e.g., serving gNB. Alternatively, absolute location relative to the device center in terms of 2D or 3D coordinates or in terms of named direction such as north, south-east, etc. may be provided. The WTRU capability information may be sent using higher layer signaling (e.g., RRC uplink message). In an embodiment, the WTRU capability information may be sent as uplink control information over the control channel (e.g., PUCCH).

The WTRU may receive beam failure recovery configuration from the network (e.g., serving/source gNB). The beam failure recovery configuration may contain one or more parameters. The WTRU may be configured with multiple beam failure recovery configurations, each containing one or more parameters with different value compared to other configurations, may have an identification, e.g., beam failure recovery configuration ID. In an embodiment, the WTRU may also receive association/mapping between the beam failure recovery configuration and the WTRU beam (e.g., WTRU Tx/Rx beam).

In an embodiment, the value of the beam failure recovery timer (e.g., beamFailureRecovery Timer) may be associated with the selected WTRU's Tx/Rx beam. The value of the beam failure recovery timer may include the timer for beam failure recovery where upon expiration of this timer, the WTRU may not use contention free random access to establish connection with the serving/source gNB.

Different/separate values for the beam failure recovery timer may be configured for any (e.g., each) or a set of WTRU beams. For example, referring to FIG. 8, the edge beams (e.g., beam 1, beam 2, beam 8, beam 9) may be configured with lower value of beam failure recovery timer (e.g., beamFailureRecoveryTimer=10 ms) compared to the value assigned for central beams (e.g., beam 5 and beam 6), e.g., beamFailureRecovery Timer=80 ms. This is because when the WTRU uses/selects one of the edge beams to communicate with the serving/source gNB and if the WTRU rotates and the channel quality deteriorates, the source gNB may probably be out of the FoV. Therefore, with lower value of beam failure recovery timer, the time spent in beam failure recovery may be reduced and the radio link failure may be declared sooner. Beams may be grouped and may be assigned same value of the beam failure recovery timer. Alternatively, each beam may be assigned with a different/separate value of the beam failure recovery timer. The WTRU may use the associated value of the beam failure recovery timer based on the selected WTRU Tx/Rx beam. If the WTRU switches the WTRU Tx/Rx beam, the WTRU may use the beam failure recovery timer associated with the new WTRU Tx/Rx when the WTRU performs beam failure recovery procedure.

In an embodiment, the configuration for random access procedure to perform beam failure recovery (e.g., configured in RRC information element RACH-ConfigGeneric) may be associated with the selected WTRU's Tx/Rx beam. Different/separate random access procedure configurations may be configured for any (e.g., each) or a set of WTRU beams. For example, the configuration of random access procedure may be configured such that the beam failure recovery procedure may be shortened for the edge WTRU beams compared to the center WTRU beams. For example, the total number of preambles used for random access may be configured as a function of the WTRU's beams. For example, referring to FIG. 8, the edge beams (e.g., beam 1, beam 2, beam 8, beam 9) may be configured with lower value of total number of preambles compared to the value assigned for central beams (e.g., beam 5 and beam 6). In an embodiment, different values for the time-frequency resources, e.g., number of SSBs per RACH occasion or/and number of (e.g., contention based) preambles per SSB, may be configured as a function of the WTRU's beams. In an embodiment, different values for the power ramping step or/and scaling factor for the backoff indicators may be configured as a function of the WTRU's beams. Based on the selected WTRU Tx/Rx beam, the WTRU may use the associated random access configuration to perform the beam failure recovery. If the WTRU switches the WTRU Tx/Rx beam, the WTRU may use the random access configuration associated with the new WTRU Tx/Rx when the WTRU performs beam failure recovery procedure.

In an embodiment, a value of the threshold, e.g., RSRP threshold (rsrp-ThresholdSSB), which is used to determine whether a beam is a candidate beam (e.g., when the received signal quality RSRP>threshold) to perform the beam failure recovery, may be associated with the selected WTRU's Tx/Rx beam. Different/separate values of the threshold may be configured for any (e.g., each) or a set of WTRU beams.

In an embodiment, a maximum value of the duration (e.g., maximum beam search timer) may be configured to the WTRU (e.g., by the network, e.g., serving/source gNB) to search for a candidate beam (e.g., received signal quality, e.g., RSRP/RSSI is above a threshold) during the beam recovery procedure. The WTRU may be configured to declare radio link failure if the timer (e.g., maximum beam search timer) expires, e.g., the WTRU may be not able to determine a candidate beam of the serving/source gNB before the time expires. Different/separate values for the timer (e.g., maximum beam search timer) may be configured for any (e.g., each) or a set of WTRU beams. For example, referring to FIG. 8, the edge beams (e.g., beam 1, beam 2, beam 8, beam 9) may be configured with lower value of the timer compared to the value assigned for central beams (e.g., beam 5 and beam 6).

In an embodiment, a combined (e.g., single) timer (e.g., maximum overall beam failure recovery timer) may be configured to the WTRU which may take both candidate beam search and the random access procedure into account. The WTRU may be configured to declare radio link failure if the timer (e.g., maximum overall beam failure recovery timer) expires, e.g., the WTRU may be not able to determine a candidate beam of the serving/source gNB and complete the RACH procedure before the time expires. Different/separate values for the timer (e.g., maximum overall beam failure recovery timer) may be configured for any (e.g., each) or a set of WTRU beams. For example, referring to FIG. 8, the edge beams (e.g., beam 1, beam 2, beam 8, beam 9) may be configured with lower value of the timer compared to the value assigned for central beams (e.g., beam 5 and beam 6).

The beam failure recovery configuration with one or more parameters (e.g., one or more of beam failure recovery timer, random access procedure configurations, RSRP threshold, maximum beam search timer, or/and maximum overall beam failure recovery timer, etc.) associated with the WTRU's Tx/Rx beam may be given to the WTRU by the network (e.g., serving/source gNB), via higher layer signaling, e.g., RRC signaling, system information, MAC-CE, or DCI.

In an embodiment, for example, when the WTRU is configured with multiple beam failure recovery configurations, and on a condition that the WTRU switches its Tx/Rx beam and determines to switch the beam failure recovery configuration (e.g., start using the different configuration from the previous one), the WTRU may send an indication to the network, e.g., serving/source gNB. The difference in the configuration with respect to the previous one may be for example in one of beam failure recovery timer, random access procedure configurations, RSRP threshold, maximum beam search timer, or/and maximum overall beam failure recovery timer, etc. The indication may contain the ID of the beam failure detection configuration the WTRU determines to switch. In an embodiment, the indication may contain the parameter (e.g., beam failure recovery timer, random access procedure configurations, RSRP threshold, maximum beam search timer, or/and maximum overall beam failure recovery timer, etc.) and its value (e.g., new value) which the WTRU may determine to switch. The WTRU may be configured to send the indication to the network via, MAC-CE, or RRC signaling or as uplink control information.

In an embodiment, the WTRU may be pre-configured with multiple beam failure recovery configurations (e.g., each configuration may be identified with an ID, and may have different values of one or more parameters in association with one or more WTRU's Tx/Rx beams compared to other configurations) and only one configuration may be activated initially. The pre-configuration and the activated configuration may be given to the WTRU by the network, via for example, higher layer signaling, e.g., RRC signaling or system information. The WTRU may be configured with event-based reporting for its selection of one of the edge beams. In another example, the WTRU may be configured to send periodic, semi-persistent or aperiodic reports containing the WTRU Tx/Rx beam information to the WTRU. The network (e.g., serving/source gNB) may determine to configure different beam failure recovery configuration based on the WTRU's Tx/Rx beam selection. After sending such report, the WTRU may receive an activation command, e.g., using RRC signaling, MAC-CE command, or a DCI, containing the beam failure recovery configuration ID to be activated. After receiving an activation command, the WTRU may deactivate the previous configuration and may start using the latest received beam failure recovery configuration.

In an embodiment, the WTRU may be configured with one beam failure recovery configuration initially via for example, higher layer signaling, e.g., RRC signaling or system information. After sending a report (e.g., event based, or periodic/semi-persistent/aperiodic), the WTRU may receive another (e.g., new) beam failure recovery configuration from the network, e.g., using RRC signaling, MAC-CE command, or a DCI, containing the values of the parameters, e.g., beam failure recovery timer, RSRP threshold, RACH configuration, etc. After receiving the new beam failure recovery configuration, the WTRU may start using that configuration.

In an embodiment, when SRSs are used for uplink beam management and the WTRU is configured to assign different SRS, e.g., SRS ID, for each WTRU Tx beam and the association between the physical beams and the SRS IDs may be configured to the WTRU, the network may determine the WTRU orientation (e.g., which WTRU Tx beam is being used/selected by the WTRU) based on the selected SRS for uplink transmissions. The association between the physical beams and the SRS IDs for each antenna panel may be configured to the WTRU by the network via higher layer signaling, e.g., RRC signaling, or system information. Based on the network (e.g., serving/source gNB) determination of the WTRU orientation using the selected SRS ID or WTRU reports, the network (e.g., serving/source gNB) may dynamically configure the WTRU with the appropriate beam failure recovery configuration based on the WTRU beam associated with the SRS ID. The beam failure recovery configuration may be sent to the WTRU dynamically using for example, MAC-CE, DCI, or RRC signaling. After receiving the new beam failure recovery configuration, the WTRU may start using that configuration.

In an embodiment, beam failure recovery configuration may be antenna panel specific. The WTRU may provide an indication when there is any change in the antenna panel used to communicate with the serving/source gNB, and the WTRU may receive (e.g., new/different/another) beam failure recovery configuration associated with the new antenna panel if the configuration for the requested/reported antenna panel is not already available at the WTRU (e.g., configured by the network earlier).

In an embodiment, a method performed by a WTRU to support beam failure recovery procedure may comprise at least one of the following actions:
The WTRU may send, to the network, WTRU capability information containing the number of antenna panels, (e.g., maximum) angular coverage of any (e.g., each) antenna panel, maximum/minimum WTRU Tx/Rx beam-width (e.g., 3 dB or half power beam width), or/and location of the antenna panels on the WTRU, etc.

The WTRU may receive, from the network, one or more beam failure recovery configurations, at least one (e.g., each) of the beam failure recovery configurations containing ID, different/separate values of one of more parameters associated with one or more WTRU's Tx/Rx beams.

On a condition when the WTRU's beam is changed with the same antenna panel and the same serving/source gNB, the WTRU may determine the beam failure recovery configuration to be used based on the selected WTRU beam.

The WTRU may send, to the network, WTRU indication containing the beam failure recovery configuration ID if the beam failure configuration is different from the previously selected configuration.

Referring to the above method:

the indication may contain the parameter (e.g., beam failure recovery timer, random access procedure configurations, RSRP threshold, maximum beam search timer, or/and maximum overall beam failure recovery timer) and its value (e.g., new value) which the WTRU determines to switch.

the WTRU may receive association between the beam failure recovery configuration and the WTRU beam: in the beam failure recovery configuration, the value of the beam failure recovery timer may be associated with the WTRU beam or a group of WTRU beams; in the beam failure recovery configuration, the value of the RSRP threshold used to determine a candidate beam may be associated with the WTRU beam or a group of WTRU beams; in the beam failure recovery configuration, the value of one or more parameters in RACH configurations from total number of preambles, number of SSBs per RACH occasion, number of (e.g., contention based) preambles per SSB, power ramping step, scaling factor for the backoff indicators, may be associated with the WTRU beam or a group of WTRU beams; in the beam failure recovery configuration, the value of the maximum beam search timer used as maximum duration to search for a candidate beam search may be configured and may be associated with the WTRU beam or a group of WTRU beams; in the beam failure recovery configuration, the value of the maximum overall beam failure recovery timer used as maximum duration to search for a candidate beam search and to perform RACH may be configured and may be associated with the WTRU beam or a group of WTRU beams.

the WTRU may be configured with multiple beam failure recovery configurations with one configuration activated initially: the WTRU may be configured to report (event based when UWTRU starts using one of the N edge beams, periodic, semi-persistent or aperiodic) about its selected Tx/Rx beam the WTRU may be configured to activate a beam failure recovery configuration based on its reporting of the WTRU Tx/Rx beam.

the WTRU may be configured with an association mechanism between the physical beams and the SRS IDs for each antenna panel: the WTRU may use SRS IDs to report the WTRU beams (if configured) the WTRU may receive beam failure recovery configuration when there is any change in the WTRU beam and the network determines to change the configuration based on its detection of WTRU beam change using the SRS IDs.

the WTRU may be configured with beam failure recovery configurations for each antenna panel.

the WTRU may be configured to send an indication when there is any change in the antenna panel used/selected by the WTRU to communicate with the network: after sending the antenna panel change indication, the WTRU may receive new beam failure recovery configuration (with its association with the WTRU beams) for the new antenna panel.

To verify the performance gain of some of the various embodiments, system level simulations may be conducted using a MATLAB based discrete time event simulator to evaluate the WTRU connectivity with the rotations. As a non-limited example, we consider a deployment scenario where 3 m tall gNBs are deployed on a circle of radius 10 m around the WTRU of interest residing at the center. Two different densities of the gNBs are considered, where 4 and 8 gNBs, deployed uniformly on the circle, 90 degree and 45 degrees apart, respectively. The average outage performance of the WTRU is computed by running the simulations for one hundred iterations, where each iteration length is equivalent to four hours of simulation time.

Multiple rotation speeds have been tested to observe trend. Although, a more frequent rotation leads to more frequent handovers and thus worse overall performance, here, results are presented with only one setting. Average time between two consecutive rotations is set to 5 seconds. For each rotation, the angle is uniformly selected from the range of 15 to 75 degrees. The direction of the rotation (e.g., clockwise or anti-clockwise) is randomly selected with equal probability at each instance of the rotation. Multiple antenna array (AA) configurations are considered at the WTRU side where the number of AAs ∈ {1,2,3}. Each AA is assumed to be with 90 degrees of field of view. In case of multiple AAs, the placement of AAs is assumed to be next to each other, hence, the WTRU has a total field of view range of 90 degrees, 180 degrees and 270 degrees, using 1, 2, and 3 AAs, respectively. Deployment densities below 4 gNBs with coverage holes for a UE with the FoV range of 90 degrees are not evaluated. The outage probability is calculated as 1-reliability, where reliability is defined as {time spent in connected state}/{total simulation time}.

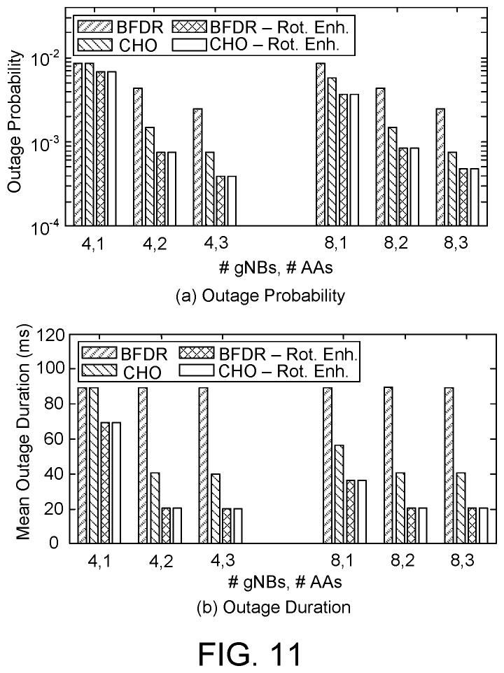

Referring to FIG. 11, the performance with four different techniques are compared: (i) BFDR: with this technique the WTRU may perform beam failure detection and recovery procedure as soon as the link with the source gNB goes out of the coverage due to the WTRU rotation. The WTRU may (e.g., only) be able to discover and make connection with another gNB when the WTRU declares the radio link failure with the source gNB after the completion of beam failure detection and recovery; (ii) CHO: with this technique, the WTRU may be pre-configured by the source gNB with handover configuration for the candidate target neighboring gNBs which are available in the WTRU's field of view. The WTRU may be able to make measurements with those neighboring gNB while the WTRU may be connected to the source gNB; (iii) BFDR-Rot. Enh: in this BFDR with rotational specific enhancement, the WTRU may declare (e.g., transmit to the network) link failure detection with the source gNB as soon as the source gNB goes out of the coverage due to the WTRU rotation. The WTRU may (e.g., instantaneously) start discovering other gNBs; (iv) CHO-Rot. Enh: in this CHO with rotational specific enhancement, the WTRU may be pre-configured with handover configuration for target neighboring gNBs which may not be in the current field of view while the WTRU is connecting to the source gNB but may come in the field of view after the WTRU rotation.

FIG. 11 presents the WTRU connectivity performance in terms of outage probability and outage duration for four techniques with gNB discovery time of 50 ms, connection establishment time of 20 ms, beam failure detection duration of 20 ms, beam failure recovery duration of 50 ms, and CHO trigger/execution time of 20 ms. Referring to FIGS. 11(a) and (b), the CHO outperforms BFDR in every deployment scenario both in outage probability (a) and mean outage duration (b), as long as additional gNBs may be discovered either by an increased deployment density or a more advanced WTRU antenna array placement. Specifically, FIG. 11(a), we observe that in the 8 gNB and 3 AA scenario, CHO experiences three times smaller outage probability as compared to BFDR. However, in the scenario with 4 gNBs and 1 AA, the performances of BFDR and CHO are identical since there are no candidate gNBs available to be configured as CHO targets.

Referring to FIG. 11(a), when the deployment density is doubled, from 4 gNB to 8 gNBs, the outage probability is reduced only by a small margin. In scenarios where the WTRU rotation is the main limitation of the system, as long as there is no coverage hole, increasing deployment density is not beneficial since after a rotation event, all the gNBs experience a change at the same time. For example, after a large rotation event, once the source gNB is out of the field of view, the WTRU may (e.g., only) establish connection either i) after going through BFDR procedure and declaring radio link failure, or ii) if CHO is configured after a CHO trigger/execution time. Thus, the WTRU may go through time consuming procedures before establishing a new connection even if a new gNB is available. Increasing the number of AAs may help reducing the outage probability and the mean outage duration for both BFDR and CHO. A WTRU with multiple AAs may combine them to achieve a large overall FoV. After a rotation event, the WTRU may coordinate between AAs to seamlessly maintain connection with the same gNB, leading to increased performance. Specifically, in the 4 gNB CHO scenario, a WTRU with 2 AAs may achieve five times lower outage probability and 50 ms shorter average outage duration than a WTRU with a single AA. Similar improvements in outage probability are observed for other configurations as well. Even though going from 2 AAs to 3 AAs, the average outage duration may not further reduce, outage events may become less frequent leading to an overall improvement of the system performance.

FIG. 11(b) depicts the average outage duration for different number of AAs, handover methods, and deployment densities. Note that in all scenarios, the outage duration of BFDR is approximately 90 ms, which corresponds to total time passed during BFDR and connection establishment procedures. Note that as long as the gNB is in WTRU's field of view, the discovery may be handled in the background (e.g., during the BFDR procedure). The outage duration of CHO when there are 4 gNBs and 1 AAs is approximately 90 ms, which corresponds to similar outage duration as in the BFDR case, since there are no possible CHO target gNBs. Once CHO targets are available, a much shorter outage may be achieved by CHO. In such scenarios, the outage duration is significantly reduced to approximately 40 ms, which corresponds to CHO execution/trigger time and the connection establishment time, where CHO execution/trigger time may be the time until failure is detected, and CHO is triggered.

FIGS. 11(a) and (b) illustrate the advantages of the rotational mobility (e.g., specific) enhancements for BFDR and CHO described. Once the enhancements are in use, the failure detection may be shortened for both BFDR and CHO. Without long delays, BFDR may declare RLF and initiate a connection establishment with a discovered gNB. Similarly, with WTRU orientation based CHO target configuration, CHO may be performed after the WTRU rotation without long delays in radio link failure procedure. In both scenarios, if a discovered gNB is available, the outage duration may be connection establishment delay. If a gNB is not discovered, the outage duration may amount to gNB discovery delay and connection establishment delay. When rotation (e.g., specific) enhancements are applied, both BFDR and CHO achieve similar outage probability. In the 4 gNB and 2 AA scenario, the rotational mobility (e.g., specific) enhancements may achieve up to 5.77 times and 2 times reduction in outage probability for BFDR and CHO, respectively. Similarly, from FIG. 11(b), both BFDR and CHO may achieve similar outage duration. Specifically, in 4 gNB and 1 AA scenario, both BFDR and CHO achieve a shortened outage duration of approximately 70 ms, which corresponds to discover and establish a connection with a new gNB avoiding the failure detection delays. The improvements are much more prominent in scenarios where a candidate gNB may be discovered beforehand if it is within the FoV of an AA. This can be achieved with a higher deployment density of gNBs or having multiple AAs at WTRUs. In such scenarios, the outage delays of both BFDR and CHO may be reduced to approximately 20 ms, corresponding to connection establishment delay.

WTRUs may be equipped with multiple antenna panels (e.g., one or more panels) to enable faster antenna panel selection/switching at the WTRU or/and faster handover between intra or/and inter-cell transmission reception points (TRPs).

A WTRU may send its information to the network (e.g., source gNB) to indicate its capability to support multiple antenna panels. The WTRU may send its multiple antenna panels capability wherein the capability information may include the number of supported antenna panels, and one or more of attributes of one of more antenna panels. The attributes of the one or more antenna panels may include any of: identification of the antenna panel (e.g., an identifier or index associated with the antenna panel), number of beams supported by the antenna panel, angular coverage of the antenna panel, supported beam-widths for one or more beam within the antenna panel, type of antenna panel showing if the antenna panel may be used for uplink or downlink or both types of links, type of any (e.g., each) antenna panel showing if the antenna panel can be used for measurements only or communication (e.g., data transmission) only or control signaling only or combinations of one or more of these functions, number of layers or/and number of different ports supported for the antenna panel, etc. The WTRU may also send the layout of an antenna panel, e.g., indicating the location of the antenna panel (e.g., with respect to each other) on the WTRU. For example, the WTRU may send the absolute location of an antenna panel, or the relative location (e.g., in terms of 2-D/3-D coordinates or/and angular distance in horizontal and azimuth angles) of an antenna panel with respect to an antenna panel for which the absolute location is sent. Another example, the WTRU may send the relative location (e.g., in terms of 2-D/3-D coordinates or/and angular distance in horizontal and azimuth angles) of an antenna panel with respect to a global reference or with respect to a DL beam (e.g., selected during the initial access) or an UL beam (e.g., for which measurements available at the gNB).

The WTRU may be configured to make measurements (e.g., L1 measurement or L2/L3 measurements) using one or more DL beams (e.g., using associated CSI-RSs/SSBs or any other DL signal like control channel) associated with one or more TRPs (e.g., intra or/and inter-cell TRPs). Measurements may be configured on periodic/semi-persistent/aperiodic basis. DL signals/resources, e.g., CSI-RSs or/and SSBs may be given to the WTRU to make measurements. The WTRU may be configured to report measurements. The measurement reporting may be configured on periodic/semi-persistent/aperiodic basis or event-based. The WTRU may use one or more antenna panels to make measurement using one or more DL signals/resources (e.g., CSI-RSs/SSBs/PDCCH/PDSCH). Alternatively, the WTRU may be configured with the antenna panel/panels over which the measurements need to be made. For example, for each DL signal/resource configured for the measurements, the WTRU may also be given one or more antenna panels which need to be used to make measurements. Associated antenna panel (e.g., antenna panel ID) may be reported with measurements. These measurement reports may be used by the network to determine/update Transmit Configuration Indication (TCI) configurations associated with one or more antenna panels or/and TRPs.

The WTRU may be provided with one or more TCI configurations indicating one or more source DL signals/resources (e.g., CSI-RSs, SSBs, etc.) associated with one or more antenna panels or/and TRPs. Different (e.g., separate) or same TCI configurations may be provided for DL and UL. The WTRU may be configured to make measurements on one or more antenna panels using the associated TCI configurations. TCI configuration(s) may be dynamically updated (e.g., using DL MAC-CE or DCI) for an antenna panel. Alternatively, multiple TCI configurations for an antenna panel may be given to the WTRU using for example, RRC signaling, and then one or more TCI configurations may be dynamically activated or deactivated for an antenna panel using for example, DL MAC-CE or DCI. In another solution, one or more downlink control (e.g., PDCCH) or data channel (e.g., PDSCH, e.g., measurements using the associated DMRSs) associated with one or more TRPs may be configured for measurements on an antenna panel. Measurements may be in the form of one or more of: RSRP, RSSI, SNR, SINR, BLER, BER, etc.

Antenna panels may be categorized in different sets. For example, a state may be defined for an antenna panel, where a state of an antenna panel may be defined as serving (e.g., a serving antenna panel) or candidate (e.g., a candidate antenna panel) or other (neither serving nor candidate) based on the configured measurements and the conditions. A serving antenna panel may be used for DL/UL communication (e.g., for data, measurements, other control information transmission/reception) with the network. A candidate antenna panel may be used for DL measurements or/and control information transmission/reception. An antenna panel which is neither serving not candidate may only be used for DL measurements. The WTRU may be configured for example, to make more frequent measurements using serving and candidate antenna panels compared to other antenna panels (e.g., non-serving and non-candidate antenna panels). This may be used for power saving purpose at the WTRU side.

A WTRU may be configured to make measurements on one or more antenna panels using an associated TCI configuration (e.g., DL CSI-RSs/SSBs). The WTRU may be configured with one or more conditions/events based on DL measurements (L1/L2/L3 measurements) to determine antenna panel switching or/and inter/intra-cell TRP handovers. In an embodiment, the WTRU may be configured with one or more quality thresholds (e.g., RSRP/RSSI/SINR/SNR/BER/BLER threshold, etc.). The configuration of events and thresholds associated with one or more beams or/and one or more antenna panels may be given to the WTRU using higher layer signaling (e.g., RRC), or system information or MAC-CE.

The WTRU may use the DL measurements (e.g., using the CSI-RS/SSB configured in the associated TCI configuration, or/and associated downlink signal, e.g., downlink control channel) made at one or more antenna panels and the configured thresholds for panel selection/switching purpose. The dynamic selection of one or more antenna panels using the DL measurements may be used to handle WTRU mobility (e.g., rotations).

The WTRU may use the DL measurements made at an antenna panel to determine if this antenna panel may be as serving or candidate antenna panel. For example, an antenna panel may be determined as a serving antenna panel by the WTRU if one or more DL measurements (e.g., or a configured number of measurements) or over a configured duration (e.g., time to trigger) made at the antenna panel are measured above a configured threshold for example, when RSRP of a configured CSI-RS received at the antenna panel is above a configured threshold T1. Multiple measurements may be taken into account over a configured time period and average of the measurements may be used to compare it with the configured threshold to determine if the antenna panel can be a serving antenna panel or not. The WTRU may have one or more serving antenna panels. The WTRU may switch or select different antenna panels as serving antenna panels based on the measurements. Using this technique, the WTRU may dynamically update its serving antenna panel set containing one or more antenna panels.

Different (e.g., separate) conditions (e.g., separate thresholds, time-to-trigger) may be used by the WTRU to categorize a serving antenna panel for downlink or uplink or for both types of transmissions.

The WTRU may also be configured to select one or more antenna panels as candidate antenna panels. For example, an antenna panel may be determined as a candidate antenna panel by the WTRU if one or more DL measurements made at the antenna panel are above a configured threshold, e.g., when RSRP of a CSI-RS received at the antenna panel is above a configured threshold T2 (e.g., T2<T1). Multiple measurements may be taken into account over a configured time period and average of the measurements may be used to compare it with the configured threshold to determine if the antenna panel may be a candidate antenna panel or not. The WTRU may have one or more candidate antenna panels. The WTRU may switch or select different antenna panels as candidate antenna panels based on the measurements. Using this technique, the WTRU may dynamically update its candidate antenna panel set containing one or more antenna panels. Different (e.g., separate) conditions, e.g., separate thresholds, time-to-trigger, may be used by the WTRU to categorize a candidate antenna panel for downlink or uplink or for both types of communications.

A candidate antenna panel may become a serving antenna panel. A candidate antenna panel may become a serving antenna panel if one or more conditions are satisfied for example, if the quality of DL measurements may become better (e.g., RSRP>T1). Similarly for example, in an embodiment, a serving antenna panel may become a candidate antenna panel if the quality of DL measurements may become worse (e.g., RSRP<T1 but RSRP>T2). A serving or candidate antenna panel may become non-serving & non-candidate antenna panel for example, when the quality of DL measurements may become worse (e.g., RSRP<T2).

The WTRU may use other constraints (e.g., power saving) to determine an antenna panel as a serving or candidate.

In an embodiment, the WTRU may indicate its (e.g., preferred) selection containing serving or/and candidate antenna panels to the network for example, when there is any change in the state of an antenna panel. The WTRU may include only the antenna panels for which the state is changed based on the latest measurements. In one solution, explicit antenna panel IDs may be used. Alternatively, TCI indications (QCL reference with respect to a DL or UL beam) may be used to indicate the associated antenna panel. Alternatively, different sets may be configured containing one or more WTRU antenna panels with combination of different possible states across all the antenna panels with each set is given an index. This configuration of sets may be configured by the network or may be communicated to the network by the WTRU (e.g., in the WTRU capability information). When there is any change in the state of an antenna panel, the WTRU may (e.g., just) include the index of the set containing state of the different antenna panels based on the latest measurements.

The information containing the latest panel state of one or more antenna panels may be sent on periodic or aperiodic or semi-persistent basis. For example, the WTRU may be configured (e.g., using RRC configuration) with periodic PUCCH resources to send this information. In an embodiment, the WTRU may receive a DCI or MAC-CE message asking to send this info on dynamic or aperiodic basis using configured resources on PUSCH or PUCCH. In an embodiment, the WTRU may be configured to send this information on semi-persistent basis, e.g., using RRC (for a set of periodic configurations including the uplink resources) and MAC-CE or DCI (for activation/deactivation of one of the selected periodic configurations). In an embodiment, after sending the selection indication to the network, the WTRU may use the antenna panel/panels as per the latest determined states if the WTRU receives a confirmation (e.g., an acknowledgement) from the network. In an embodiment, the confirmation (e.g., acknowledgement) message the network may indicate the selected (e.g., selected by the network) antenna panel/panels, e.g., which may be the same or sub-set or different antenna panels from the antenna panels indicated by the WTRU.

Based on the WTRU indication of serving/candidate antenna panel selection, the DL measurement configurations (e.g., periodicity of the resources, frequency resource allocation, changes in TCI configuration for a TRP/panel, quality thresholds configured for the event/conditions for antenna panel selection, etc.) may be updated for the WTRU.

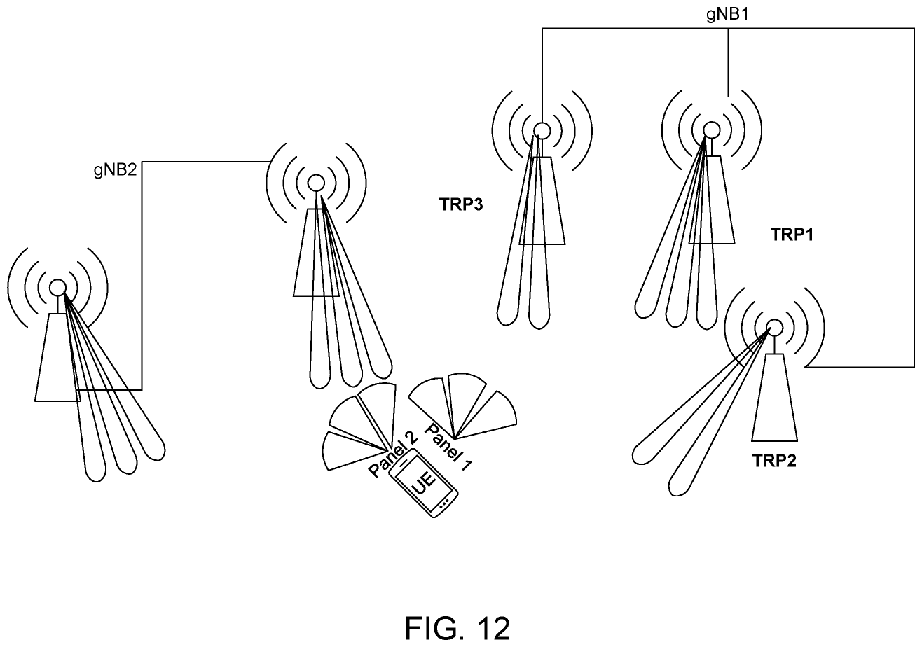

In an embodiment, the WTRU may be configured with conditions using the DL measurements over one or antenna panels for handover to different cells or TRPs of the non-serving cell. For example, the WTRU may be configured with one or more quality thresholds to be compared with one or more DL measurements at one or more antenna panels (e.g., same or different thresholds for each panel) to determine if the WTRU may trigger handover to another cell/TRP. In an embodiment, the network may use antenna panel layout at the WTRU or/and the TRP/cell layout to determine handover configuration for the WTRU. Based on the measurements on different antenna panels, the WTRU orientation may be determined in some of the cases, for example, as shown in FIG. 12, if one or more DL measurements associated with the gNB1 are above a first configured quality threshold for the antenna panel 1 but below a second quality configured threshold for the antenna panel 2, knowing the relative locations of the antenna panels, the WTRU orientation may be estimated by the gNB1, and the WTRU may be configured with handover configuration for the gNB2. The WTRU may be configured with CHO configurations containing the handover configurations for one or more non-serving gNBs/cells where, for example, CHO evaluation conditions may include DL measurements in association with WTRU antenna panels. For different non-serving cells, evaluation conditions may differ in terms of one or more antenna panels need to be used to make measurements. For example, for one or more non-serving cells/gNBs, the CHO execution condition may contain any of the reference signals information (e.g., reference signals to be measured, time-frequency resources, etc.), one or more antenna panels which need to be used to make measurements, and the thresholds that may need to be applied to derive the handover conditions based on the measurements (e.g., L1/L3 events-based measurements). If the CHO execution condition is satisfied based on the WTRU measurements: the WTRU may detach from the serving/source gNB, and the WTRU may apply the given handover configuration for the selected candidate gNB/cell to synchronize and to handover to the selected gNB/cell.

In an embodiment, the WTRU may be configured with event-based measurement reporting for one or more DL beams, indicated using the TCI configurations, measured over the associated one or more antenna panels. The WTRU may be configured to send measurement report(s) for one or more beam (e.g., CSI-RS/SSB/other DL signal) when an event occurs, e.g., when the L1 measurement quality (e.g., RSRP, RSSI, SNR, SINR, BLER, or BER, etc.) of a DL beam over a configured number of measurements or over a configured duration (e.g., time to trigger) falls below (e.g. or increase above) the configured threshold. Multiple measurements may be taken into account over a configured time period and average of the measurements may be used to compare it with the configured threshold to determine if the event/condition is occurred or not. In one example, the WTRU may select one or more antenna panels to make measurement over the configured DL beams. In another example, the WTRU may be configured to make antenna panel (e.g., specific) measurements. For example, the WTRU may be configured with one or more antenna panels to be used to make measurements for a configured DL beam. A measurement report may include at least any of beam IDs (e.g., associated reference signal ids), associated measurements, associated panel/panels, etc. Separate or joint measurement report (e.g., event-based or periodic) may be sent for any (e.g., each) antenna panel. The configuration of event-based measurements, e.g., DL beams, number of measurements or duration over which the measurements need to be made, antenna panel information, and thresholds associated with one or more beams or/and one or more panels may be given to the WTRU using higher layer signaling (e.g., RRC), or system information or MAC-CE. The WTRU may send the reports (e.g., when one or more condition is satisfied) in an uplink RRC or MAC-CE message.

In an embodiment, the WTRU may be configured with periodic measurement reporting, e.g., using higher layer signaling, e.g., RRC or MAC-CE, containing the measurement reporting configuration or/and the periodic uplink resources, e.g., including periodicity, time offset, prohibit timer, uplink control channel (e.g., PUCCH) configuration (e.g., format, time/frequency resources, etc.) to be used to send measurement reporting. In another solution, the WTRU may be configured with a dynamic aperiodic measurement reporting, e.g., using downlink control information containing the measurement reporting configuration or/and the uplink resource (e.g., on the uplink shared channel) to be used to send measurement reporting. If the WTRU does not have allocated resources for measurement reporting, the WTRU may request, to the network (e.g., serving gNB), to allocate the time-frequency resources (e.g., by sending a scheduling request).

Measurements (e.g., L1 measurements) for one or more beams of one or more TRPs performed at WTRU using one or more antenna panels may be used by the network (e.g., serving/source gNB) for one or more purpose. Event-based, periodic, or/and aperiodic L1 measurements may be used to determine any blockage between WTRU and one or more TRPs or/and may also be used to determine WTRU mobility (e.g., including WTRU orientation).

In an embodiment, the network (e.g., serving/source gNB) may use the measurement reports from the WTRU to determine which antenna panels to be selected for communication (DL or UL or both) or/and measurements (DL or UL or both). For example, the network may (e.g., dynamically) determine a serving antenna panel set containing one or more antenna panels (e.g., selected for DL/UL communication, DL/UL measurements, or/and other DL/UL control information transmission) using the measurements sent by the WTRU. In another example, the network may also determine a candidate antenna panel set containing one or more antenna panels (e.g., selected for DL/UL measurements, or/and other DL/UL control information transmission) using the measurements sent by the WTRU.

After sending the measurement reports to the network, the WTRU may receive DL messages containing the set of selected serving antenna panels or/and candidate antenna panels by the network. The DL message may be received in a DL MAC-CE message. Alternatively, the DL message may be received as a DL RRC message or as a part of a downlink control information (DCI). Explicit or implicit indications may be used to indicate the serving and candidate antenna panels. Explicit antenna panel IDs may be used. Alternatively, TCI indications (QCL reference with respect to a DL or UL beam) may be used to indicate the associated antenna panel. Alternatively, a set index, as described above in the WTRU-based solution, containing the latest selected state of the antenna panels may be sent in the DL message.

In an embodiment, the WTRU may receive network selection of serving or/and candidate antenna panels and may also be configured with conditions (as mentioned above in WTRU-based solutions) to determine if the state of an antenna panel (e.g., serving, candidate, other) changes. The WTRU may be configured to send indications if the state of an antenna panel changes.

The network may use the measurement reports to update the DL measurement configuration (e.g., periodicity of the resources, frequency resource allocation, changes in TCI configuration for a TRP/panel, etc.). For example, serving or/and candidate antenna panels may be configured with more measurements (e.g., frequent measurements) compared to other panels.

In an embodiment, the network (e.g., serving gNB) may use event-based, periodic, or/and aperiodic measurement reports to select one or more TRPs to serve the WTRU (e.g., for downlink or/and uplink control/data transmission). As a non-limited example, serving TRPs may be subset of the set of TRPs over which the measurements were configured. Event-based or/and periodic (e.g., L1) measurements may enable dynamic selection of one or more serving TRPs for the WTRU. The selected one or more TRPs may be indicated to the WTRU using for example, a downlink MAC-CE message or using a downlink control information, or RRC signaling, etc. The network may indicate the selected TRPs to the WTRU, e.g., explicitly using the TRP IDs or implicitly using the TCI framework for example, using the QCL reference (e.g., QCL ‘D’ reference) containing the associated DL/UL beam.

In an embodiment, the network (e.g., serving/source gNB) may use event-based, periodic, or/and aperiodic measurement reports from the WTRU to determine handover configuration (e.g., CHO configuration) for the WTRU with respect to one or more non-serving cells/gNBs. Such measurements may assist the serving/source gNB to determine and configure one or more potential candidate (e.g., non-serving) target gNBs for CHO. The serving gNB may send a RRC reconfiguration message containing CHO configuration of candidate gNBs and the CHO execution conditions to the WTRU. In one example, for different non-serving cells, evaluation conditions may differ in terms of one or panels need to be used to make measurements. For example, for one or more non-serving cells/gNBs, the CHO execution condition may contain the reference signals information (e.g., reference signals to be measured, time-frequency resources, etc.), one or more panels which need to be used to make measurements, the thresholds need to be applied to derive the handover conditions based on the measurements (e.g., L1/L3 events-based measurements). The WTRU may use the configuration to perform CHO.

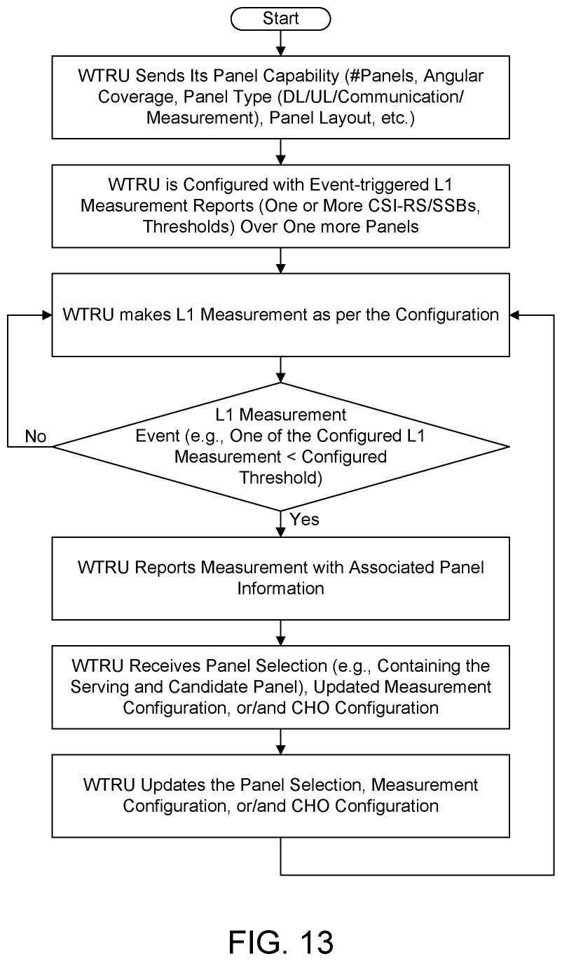

Referring to FIG. 13, in an embodiment, a method performed by a WTRU for antenna panel selection/switching may comprise at least one of the following actions:

The WTRU may send, to the network, WTRU capability information containing number of supported antenna panels, one or more of the following attributes of one or more panel: number of beams supported for an antenna panel, total angular coverage of an antenna panel, supported beam-widths of an antenna panel, type of an antenna panel (DL/UL/both), type of an antenna panel (measurements/communication/control signaling), number of layers or/and number of different ports supported for an antenna panel, antenna panel layout, etc.

The WTRU may receive, from the network, measurement configuration containing the DL signals/resources to be measured, quality thresholds, and conditions to trigger the measurement reports.

On a condition when one or more of the configured DL L1 measurements fall below or increase above the configured threshold (as per the configured condition), the WTRU may report a measurement containing one or more of: associated DL beam/resource ID, measurement, associated panel, etc.

The WTRU may receive, from the network, the configuration containing the set of serving antenna panels and candidate antenna panels.

The WTRU may update the set of serving antenna panels and candidate panels.

Referring to the above method:

The WTRU may receive, from the network, the updated DL measurement configuration after sending configured event-triggered measurement report(s)

The WTRU may receive, form the network, CHO configuration after sending configured event-triggered measurement report(s): the CHO execution condition may contain the reference signals information (e.g., reference signals to be measured, time-frequency resources, etc.), one or more antenna panels which may be used to make measurements, the thresholds that may be applied to derive the handover conditions based on the measurements (e.g., L1/L3 events-based measurements).

The WTRU may receive, from the network, the updated TRPs, explicitly using the TRP IDs or implicitly using the updated TCI framework, after sending configured event-triggered measurement report(s)

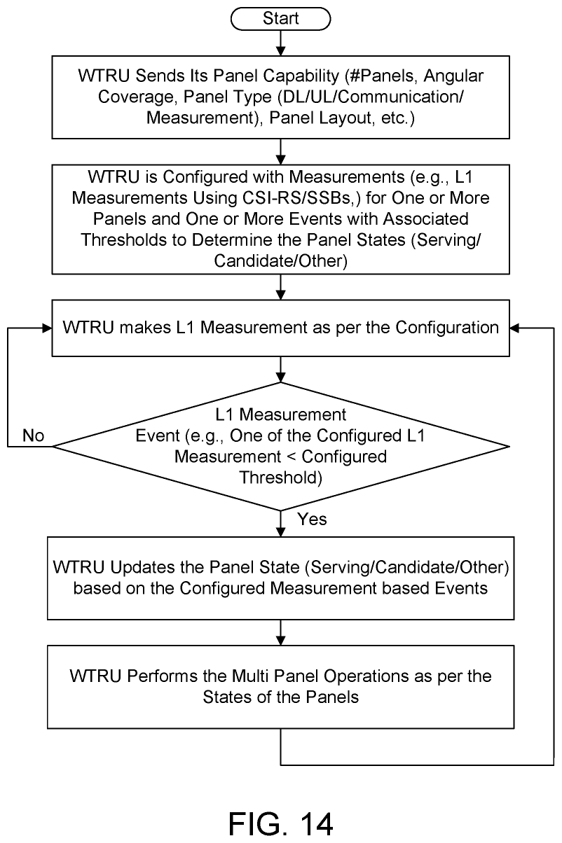

Referring to FIG. 14, in an embodiment, a method performed by a WTRU for antenna panel selection/switching may comprise at least one of the following actions:

The WTRU may send, to the network, WTRU capability information containing number of supported antenna panels, one or more of the following attributes of one or more panel: number of beams supported for an antenna panel, total angular coverage of an antenna panel, supported beam-widths of an antenna panel, type of an antenna panel (DL/UL/both), type of an antenna panel (measurements/communication/control signaling), number of layers or/and number of different ports supported for an antenna panel, panel layout, etc.

The WTRU may receive, from the network, TCI (e.g., measurement) configuration containing the DL signals/resources to be measured, quality thresholds, and conditions to trigger the antenna panel switching.

The WTRU may update the antenna panel state (e.g., serving/candidate/other) of one or antenna panels based on the configured measurements and the conditions.

The WTRU may perform operations on one or more antenna panels based on the updated states.

Referring to the method above:
different conditions may be configured for DL and UL serving/candidate antenna panels;
on a condition that the state of at least one panel is updated, the WTRU may send the indication, to the network, containing the set index showing the states of antenna panels;
on a condition that the state of at least one panel is updated, the WTRU may send the indication to the network containing the explicit indication with panel ids or implicit indication with TCI configuration associated with the panels for which the state is updated;
after sending the selection indication to the network, the WTRU may use the antenna panel/panels as per the latest determined states if the WTRU receives a confirmation (e.g., an acknowledgement) from the network:

the confirmation (e.g., acknowledgement) message from the network may indicate the selected (e.g., selected by the network) antenna panel/panels, (e.g., which may be the same or sub-set or different antenna panels from the panels indicated by the WTRU).

the WTRU may receive, from the network, the updated DL measurement configuration after sending indication of latest panel states;

the WTRU may receive, from the network, CHO configurations containing the handover configurations for one or more non-serving gNBs/cells with CHO evaluation conditions, that may include DL measurements in association with WTRU antenna panels: CHO execution condition may contain the reference signals information (e.g., reference signals to be measured, time-frequency resources, etc.), one or more antenna panels that may be used to make measurements, the thresholds that may be applied to derive the handover conditions based on the measurements (e.g., L1/L3 events-based measurements) for one or more non-serving gNBs/cells; On condition that the CHO execution condition is satisfied based on the WTRU measurements: the WTRU may detach from the serving/source gNB, the WTRU may apply the given handover configuration for the selected candidate gNB/cell to synchronize and to handover to the selected gNB/cell.

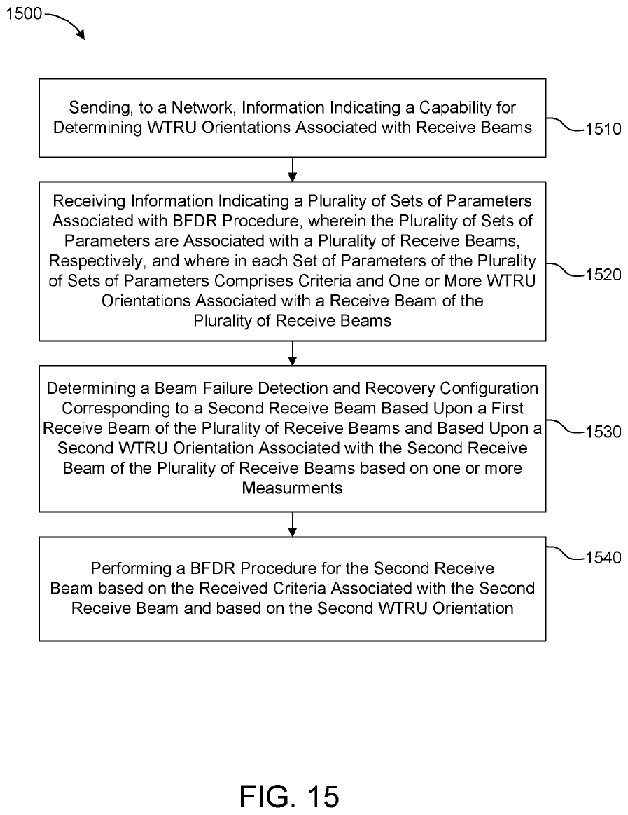

Referring to FIG. 15, in an embodiment, a method 1500 performed by a WTRU for performing beam failure and detection recovery may comprise a step of sending 1510, to a network, information indicating a capability for determining WTRU orientations associated with receive beams. The information indicating the capability for determining WTRU orientations associated with receive beams may comprise information including any of any of one or more parameters including number of antenna panels, angular coverage of at least one antenna panel, maximum/minimum WTRU Tx/Rx beam-width and location of the antenna panels on the WTRU.

The method 1500 may further comprise a set of receiving 1520 information indicating a plurality of sets of parameters associated with beam failure detection and recovery procedure, wherein the plurality of sets of parameters are associated with a plurality of receive beams, respectively, and wherein each set of parameters of the plurality of sets of parameters comprises criteria and one or more WTRU orientations associated with a receive beam of the plurality of receive beams. The received criteria of each set of parameters of the plurality of sets of parameters may be based on any of instances of beam failure counter and on beam failure detection along a period of time.

The method 1500 may further comprise a step of determining 1530 a beam failure detection and recovery configuration corresponding to a second receive beam based upon a first receive beam of the plurality of receive beams and based upon a second WTRU orientation associated with the second receive beam of the plurality of receive beams based on one or more measurements. The measurements may comprise any of rotational measurements of the WTRU and channel quality measurements. On condition that the rotational measurement exceeds a rotational threshold, the WTRU may transmit to the network information indicating a beam failure.

The method 1500, may further comprise a step of performing 1540 performing a beam failure detection and recovery procedure for the second receive beam based on the received criteria associated with the second receive beam and based on the second WTRU orientation.

The method 1500 may further comprise a step of transmitting information indicating the received criteria associated with the first receive beam.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, WTRU, terminal, base station, RNC, or any host computer.

Moreover, in the embodiments described above, processing platforms, computing systems, controllers, and other devices including processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. In an embodiment, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. A group having 1-3 cells may refer to groups having 1, 2, or 3 cells. Similarly, a group having 1-5 cells may refer to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method, implemented in a wireless transmit/receive unit, (WTRU), the method comprising:
sending, to a network, information indicating a capability for determining WTRU orientations associated with receive beams;
receiving information indicating a plurality of sets of parameters associated with a beam failure detection and recovery procedure, wherein the plurality of sets of parameters are associated with a plurality of receive beams, respectively, and wherein each set of parameters of the plurality of sets of parameters comprises criteria and one or more first WTRU orientations associated with a receive beam of the plurality of receive beams;
determining a beam failure detection and recovery configuration corresponding to a second receive beam of the plurality of receive beams based on a first receive beam of the plurality of receive beams and based on a second WTRU orientation associated with the second receive beam; and
performing a beam failure detection and recovery procedure for the second receive beam based on the received criteria associated with the second receive beam and based on the second WTRU orientation.

2. The method according to claim 1, comprising transmitting information indicating the received criteria associated with the second receive beam.

3. The method according to claim 1, wherein the WTRU comprises an antenna panel, and wherein a third WTRU orientation is associated with receive beams formed by the antenna panel.

4. The method according to claim 1, wherein the received criteria of each set of parameters of the plurality of sets of parameters are based on any of (i) one or more instances of beam failure counter and (ii) a beam failure detection period of time.

5-7. (canceled)

8. The method according to claim 1, wherein indicating the capability for determining WTRU orientations associated with receive beams comprises indicating information including any of one or more parameters including a number of antenna panels, angular coverage of at least one antenna panel, a maximum WTRU Tx beam-width, a maximum WTRU Rx beam-width, fa minimum WTRU Tx/beam-width, a minimum WTRU Rx beam-width, and, for at least one of the antenna panels, a location of the at least one antenna panels on the WTRU.

9. The method according to claim 8, wherein the angular coverage includes an azimuth dimension and an elevation dimension.

10. The method according to claim 8, wherein the location of the at least one antenna panels is relative to a location of an antenna panel used for transmitting the information to the network.

11. The method according to claim 8, wherein the location of the at least one antenna panel includes information indicating an absolute location relative to a WTRU center.

12-13. (canceled)

14. The method according to claim 1, wherein each set of parameters of the plurality of sets of parameters comprises a configuration identifier.

15. The method according to claim 1, comprising receiving information indicating configuration for transmission of multiple sounding reference signals (SRS s); and transmitting a selected SRS through different WTRU beams as per the received configuration.

16. A wireless transmit/receive unit (WTRU) comprising a processor, a transceiver unit and a storage unit, and configured to:
send, to a network, information indicating a capability for determining WTRU orientations associated with receive beams;
receive information indicating a plurality of sets of parameters associated with a beam failure detection and recovery procedure, wherein the plurality of sets of parameters are associated with a plurality of receive beams, respectively, and wherein each set of parameters of the plurality of sets of parameters comprises criteria and one or more first WTRU orientations associated with a receive beam of the plurality of receive beams;
determine a beam failure detection and recovery configuration corresponding to a second receive beam of the plurality of receive beams based on a first receive beam of the plurality of receive beams and based on a second WTRU orientation associated with the second receive beam; and
perform a beam failure detection and recovery procedure for the second receive beam based on the received criteria associated with the second receive beam and based on the second WTRU orientation.

17. The WTRU according to claim 16 configured to transmit information indicating the received criteria associated with the second receive beam.

18. The WTRU according to claim 16, comprising an antenna panel, wherein a third WTRU orientation is associated with the receive beams formed by the antenna panel.

19. The WTRU according to claim 16, wherein the received criteria of each set of parameters of the plurality of sets of parameters are based on any of (i) one or more instances of beam failure counter and (ii) a beam failure detection period of time.

20-22. (canceled)

23. The WTRU according to claim 16, wherein indicating the capability for determining WTRU orientations associated with receive beams comprises indicating information including any of any of one or more parameters including a number of antenna panels, angular coverage of at least one antenna panel, a maximum WTRU Tx beam-width, a maximum WTRU Rx beam-width, a minimum WTRU Tx beam-width, a minimum WTRU Rx beam-width, and, for at least one of the antenna panels, a location of the at least one antenna panels on the WTRU.

24. The WTRU according to claim 23, wherein the angular coverage includes an azimuth dimension and an elevation dimension.

25. The WTRU according to claim 23, wherein the location of the at least one antenna panels is relative to a location of an antenna panel used for transmitting the information to the network.

26. The WTRU according to claim 23, wherein the location of the at least one antenna panel includes information indicating an absolute location relative to a WTRU center.

27-28. (canceled)

29. The WTRU according to claim 16, wherein each set of parameters of the plurality of sets of parameters comprises a configuration identifier.

30. The WTRU according to claim 16, configured to:
receive information indicating configuration for transmission of multiple sounding reference signals (SRS s); and
transmit a selected SRS through different WTRU beams as per the received configuration.
